(19) United States
(12) Patent Application Publication
(10) Pub. No.: US 2020/0092600 A1
(43) Pub. Date: Mar. 19, 2020

(54) METHOD AND APPARATUS FOR PRESENTING VIDEO INFORMATION

(71) Applicant: HUAWEI TECHNOLOGIES CO., LTD., Shenzhen (CN)

(72) Inventors: Peiyun DI, Shenzhen (CN); Qingpeng XIE, Shenzhen (CN)

(21) Appl. No.: 16/688,418

(22) Filed: Nov. 19, 2019

Related U.S. Application Data
(63) Continuation of application No. PCT/CN2018/084719, filed on Apr. 27, 2018.

(30) Foreign Application Priority Data
May 23, 2017 (CN) 201710370619.5

(51) Int. Cl. H04N 21/435; H04N 21/431; H04N 5/232

(52) U.S. Cl. CPC H04N 21/435; H04N 5/23238; H04N 21/431

(57) ABSTRACT

A method of presenting video information includes obtaining video content data and auxiliary data. The video content data is configured to reconstruct a video picture, the video picture includes at least two picture regions, and the auxiliary data includes quality information of the at least two picture regions. The method also includes determining a presentation manner of the video content data based on the auxiliary data, and presenting the video picture in the presentation manner of the video content data.

### CROSS-REFERENCE TO RELATED APPLICATIONS

This application is a continuation of International Application No. PCT/CN2018/084719, filed on Apr. 27, 2018, which claims priority to Chinese Patent Application No. 201710370619.5, filed on May 23, 2017. The disclosures of the aforementioned applications are hereby incorporated by reference in their entireties.

### TECHNICAL FIELD

The present application relates to the streaming media processing field, and in particular, to a method and an apparatus for presenting video information.

### BACKGROUND

With increasing development and improvement of virtual reality (VR) technologies, an increasing quantity of applications for viewing a VR video such as a VR video with a 360-degree field of view are presented to users. In a VR video viewing process, a user may change a field of view (FOV) at any time. Each field of view corresponds to video data of one spatial object (which may be understood as one region in a VR video), and when the field of view changes, a VR video picture presented in the field of view of the user should also change accordingly.

In the prior art, when a VR video is presented, video data of spatial objects that can cover fields of view of human eyes is presented. A spatial object viewed by a user may be a region of interest selected by most users, or may be a region specified by a video producer, and the region constantly changes with time. Picture data in video data corresponds to a large quantity of pictures. Consequently, an excessively large data volume is caused due to a large amount of spatial information of the large quantity of pictures.

### SUMMARY

Embodiments of the present application provide a method and an apparatus for presenting video information. A video picture is divided into picture regions with different quality ranks, a high-quality picture is presented for a selected region, and a low-quality picture is presented for another region, thereby reducing a data volume of video content information obtained by a user. In some embodiments, when there are picture regions of different quality in a field of view of the user, the user is prompted to select an appropriate processing manner, thereby improving visual experience of the user.

The foregoing objectives and other objectives are achieved by using features in the independent claims. Further implementations are reflected in the dependent claims, the specification, and the accompanying drawings.

In some embodiments, a method for presenting video information includes obtaining video content data and auxiliary data, wherein the video content data is configured to reconstruct a video picture, the video picture includes at least two picture regions, and the auxiliary data includes quality information of the at least two picture regions; determining a presentation manner of the video content data based on the auxiliary data; and presenting the video picture in the presentation manner of the video content data.

In some embodiments, the at least two picture regions include a first picture region and a second picture region, the first picture region does not overlap the second picture region, and the first picture region and the second picture region have different picture quality indicated by the quality information.

In some embodiments, the quality information includes quality ranks of the picture regions, and the quality ranks correspond to relative picture quality of the at least two picture regions.

In some embodiments, the auxiliary data further includes location information and size information of the first picture region in the video picture; and correspondingly, the determining a presentation manner of the video content data based on the auxiliary data includes: determining to present, at a quality rank of the first picture region, a picture that is in the first picture region and that is determined by using the location information and the size information.

In some embodiments, the second picture region is a picture region other than the first picture region in the video picture, and the determining a presentation manner of the video content data based on the auxiliary data further includes: determining to present the second picture region at a quality rank of the second picture region.

Beneficial effects of the foregoing embodiments are as follows: Different picture regions of the video picture are presented at different quality ranks. A region of interest that is selected by most users for viewing or a region specified by a video producer may be presented by using a high-quality picture, and another region is presented by using a relatively low-quality picture, thereby reducing a data volume of the video picture.

In some embodiments, the auxiliary data further includes a first identifier that indicates whether or not a region edge of the first picture region is in a smooth state; and correspondingly, the determining a presentation manner of the video content data based on the auxiliary data includes: when the first identifier indicates that the region edge of the first picture region is not smooth, determining to smooth the region edge of the first picture region.

In some embodiments, the auxiliary data further includes a second identifier of a smoothing method used for the smoothing; and correspondingly, the determining a presentation manner of the video content data based on the auxiliary data includes: when the first identifier indicates that the region edge of the first picture region is to be smoothed, determining to smooth the region edge of the first picture region by using the smoothing method corresponding to the second identifier.

In some embodiments, the smoothing method includes grayscale transformation, histogram equalization, low-pass filtering, or high-pass filtering.

Beneficial effects of the foregoing embodiments are as follows: When there are picture regions of different quality in a field of view of a user, the user may choose to smooth a picture edge, to improve visual experience of the user, or may choose not to smooth a picture edge, to reduce picture processing complexity. In particular, when the user is notified that the edge of the picture region is in the smooth state, better visual experience can be achieved even if picture processing is not performed, thereby reducing processing complexity of a device that performs processing and presentation on a user side, and reducing power consumption of the device.

In some embodiments, the auxiliary data further includes a description manner of the location information and the size information of the first picture region in the video picture; and correspondingly, before the determining to present, at a quality rank of the first picture region, a picture that is in the first picture region and that is determined by using the location information and the size information, the method further includes: determining the location information and the size information from the auxiliary data based on the description manner.

In some embodiments, the description manner of the location information and the size information of the first picture region in the video picture includes the following: The location information and the size information of the first picture region are carried in a representation of the first picture region, or an ID of a region representation of the first picture region is carried in a representation of the first picture region, the location information and the size information of the first picture region are carried in the region representation, and the representation of the first picture region and the region representation are independent of each other.

A beneficial effect of the foregoing embodiments is as follows: Different representation manners are provided for picture regions of different quality. For example, location information and region sizes of all picture regions whose quality remains high in each picture frame are statically set, and when a high-quality picture region in each picture frame changes with the frame, a location and a size of the high-quality picture region are dynamically represented frame by frame, thereby improving video presentation flexibility.

In some embodiments, the first picture region includes a high-quality picture region, a low-quality picture region, a background picture region, or a preset picture region.

A beneficial effect of the foregoing embodiments is as follows: A high-quality region may be specified in different manners, so that an individual requirement of a viewer is met, and subjective video experience is improved.

In some embodiments, the method is applied to a dynamic adaptive streaming over hypertext transfer protocol (DASH) system, a media representation of the DASH system is used to represent the video content data, a media presentation description of the DASH system carries the auxiliary data, and the method operations include, respectively, obtaining, by a client of the DASH system, the media representation and the media presentation description corresponding to the media representation that are sent by a server of the DASH system; parsing, by the client, the media presentation description to obtain the quality information of the at least two picture regions; and processing and presenting, by the client based on the quality information, a corresponding video picture represented by the media representation.

A beneficial effect of the foregoing embodiments is as follows: In the DASH system, different picture regions of the video picture may be presented at different quality ranks. A region of interest that is selected by most users for viewing or a region specified by a video producer may be presented by using a high-quality picture, and another region is presented by using a relatively low-quality picture, thereby reducing a data volume of the video picture.

In some embodiments, the method is applied to a video track transmission system, a raw stream of the transmission system carries the video content data, the raw stream and the auxiliary data are encapsulated in a video track in the transmission system, and the method operations include, respectively, obtaining, by a receive end of the transmission system, the video track sent by a generator of the transmission system; parsing, by the receive end, the auxiliary data to obtain the quality information of the at least two picture regions; and processing and presenting, by the receive end based on the quality information, a video picture obtained by decoding the raw stream in the video track.

A beneficial effect of the foregoing embodiments is as follows: In the video track transmission system, different picture regions of the video picture may be presented at different quality ranks. A region of interest that is selected by most users for viewing or a region specified by a video producer may be presented by using a high-quality picture, and another region is presented by using a relatively low-quality picture, thereby reducing a data volume of the video picture.

In some embodiments, a client for presenting video information includes an obtaining module, configured to obtain video content data and auxiliary data, wherein the video content data is configured to reconstruct a video picture, the video picture includes at least two picture regions, and the auxiliary data includes quality information of the at least two picture regions; a determining module, configured to determine a presentation manner of the video content data based on the auxiliary data; and a presentation module, configured to present the video picture in the presentation manner of the video content data.

In some embodiments, the at least two picture regions include a first picture region and a second picture region, the first picture region does not overlap the second picture region, and the first picture region and the second picture region have different picture quality indicated by the quality information.

In some embodiments, the quality information includes quality ranks of the picture regions, and the quality ranks correspond to relative picture quality of the at least two picture regions.

In some embodiments, the auxiliary data further includes location information and size information of the first picture region in the video picture; and correspondingly, the determining module is specifically configured to determine to present, at a quality rank of the first picture region, a picture that is in the first picture region and that is determined by using the location information and the size information.

In some embodiments, the second picture region is a picture region other than the first picture region in the video picture, and the determining module is specifically configured to determine to present the second picture region at a quality rank of the second picture region.

In some embodiments, the auxiliary data further includes a first identifier that indicates whether or not a region edge of the first picture region is in a smooth state; and correspondingly, when the first identifier indicates that the region edge of the first picture region is not smooth, the determining module is specifically configured to determine to smooth the region edge of the first picture region.

In some embodiments, the auxiliary data further includes a second identifier of a smoothing method used for the smoothing; and correspondingly, when the first identifier indicates that the region edge of the first picture region is to be smoothed, the determining module is specifically configured to determine to smooth the region edge of the first picture region by using the smoothing method corresponding to the second identifier.

In some embodiments, the smoothing method includes grayscale transformation, histogram equalization, low-pass filtering, or high-pass filtering.

In some embodiments, the auxiliary data further includes a description manner of the location information and the size information of the first picture region in the video picture; and correspondingly, before determining to present, at the quality rank of the first picture region, the picture that is in the first picture region and that is determined by using the location information and the size information, the determining module is further configured to determine the location information and the size information from the auxiliary data based on the description manner.

In some embodiments, the description manner of the location information and the size information of the first picture region in the video picture includes the following: The location information and the size information of the first picture region are carried in a representation of the first picture region, or an ID of a region representation of the first picture region is carried in a representation of the first picture region, the location information and the size information of the first picture region are carried in the region representation, and the representation of the first picture region and the region representation are independent of each other.

In some embodiments, the first picture region includes a high-quality picture region, a low-quality picture region, a background picture region, or a preset picture region.

In some embodiments, a server for presenting video information includes a sending module, configured to send video content data and auxiliary data, wherein the video content data is configured to reconstruct a video picture, the video picture includes at least two picture regions, and the auxiliary data includes quality information of the at least two picture regions; and a determining module, configured to determine auxiliary data, wherein the auxiliary data is configured to indicate a presentation manner of the video content data.

In some embodiments, the at least two picture regions include a first picture region and a second picture region, the first picture region does not overlap the second picture region, and the first picture region and the second picture region have different picture quality indicated in the quality information.

In some embodiments, the quality information includes quality ranks of the picture regions, and the quality ranks correspond to relative picture quality of the at least two picture regions.

In some embodiments, the auxiliary data further includes location information and size information of the first picture region in the video picture; and correspondingly, the determining module is specifically configured to determine to present, at a quality rank of the first picture region, a picture that is in the first picture region and that is determined by using the location information and the size information.

In some embodiments, the second picture region is a picture region other than the first picture region in the video picture, and the determining module is specifically configured to determine to present the second picture region at a quality rank of the second picture region.

In some embodiments, the auxiliary data further includes a first identifier that indicates whether or not a region edge of the first picture region is in a smooth state; and correspondingly, when the first identifier indicates that the region edge of the first picture region is not smooth, the determining module is specifically configured to determine to smooth the region edge of the first picture region.

In some embodiments, the auxiliary data further includes a second identifier of a smoothing method used for the smoothing; and correspondingly, when the first identifier indicates that the region edge of the first picture region is to be smoothed, the determining module is specifically configured to determine to smooth the region edge of the first picture region by using the smoothing method corresponding to the second identifier.

In some embodiments, the smoothing method includes grayscale transformation, histogram equalization, low-pass filtering, or high-pass filtering.

In some embodiments, the auxiliary data further includes a description manner of the location information and the size information of the first picture region in the video picture; and correspondingly, before determining to present, at the quality rank of the first picture region, the picture that is in the first picture region and that is determined by using the location information and the size information, the determining module is further configured to determine the location information and the size information from the auxiliary data based on the description manner.

In some embodiments, the description manner of the location information and the size information of the first picture region in the video picture includes the following: The location information and the size information of the first picture region are carried in a representation of the first picture region, or an ID of a region representation of the first picture region is carried in a representation of the first picture region, the location information and the size information of the first picture region are carried in the region representation, and the representation of the first picture region and the region representation are independent of each other.

In some embodiments, the first picture region includes a high-quality picture region, a low-quality picture region, a background picture region, or a preset picture region.

In some embodiments, a processing apparatus for presenting video information includes a processor and a memory, the memory is configured to store code, and the processor reads the code stored in the memory, to cause the apparatus to perform the method discussed above.

In some embodiments, a computer storage medium is provided, and is configured to store a computer software instruction to be executed by a processor to perform the method discussed above.

It should be understood that beneficial effects of the various embodiments are similar to those discussed above with respect to the method embodiments, and therefore details are not described again.

### DESCRIPTION OF DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may derive other drawings from these accompanying drawings without creative efforts.

FIG. 1 is a schematic structural diagram of an MPD that is transmitted according to DASH standard and that is used for system-layer video streaming media transmission;

FIG. 2 is a schematic diagram of a framework instance that is transmitted according to DASH standard and that is used for system-layer video streaming media transmission;

FIG. 3 is a schematic diagram of bitstream segment switching according to some embodiments of the present application;

FIG. 4 is a schematic diagram of a storage manner of a segment in bitstream data;

FIG. 5 is another schematic diagram of a storage manner of a segment in bitstream data;

FIG. 6 is a schematic diagram of a field of view corresponding to a field of view change;

FIG. 7 is a schematic diagram of a spatial relationship between spatial objects;

FIG. 8 is a schematic diagram of a relative location of a target spatial object in panoramic space;

FIG. 9 is a schematic diagram of a coordinate system according to some embodiments of the present application;

FIG. 10 is a schematic diagram of another coordinate system according to some embodiments of the present application;

FIG. 11 is a schematic diagram of another coordinate system according to some embodiments of the present application;

FIG. 12 is a schematic diagram of a region according to some embodiments of the present application;

FIG. 13 is a schematic flowchart of a method for presenting video information according to some embodiments of the present application;

FIG. 14 is a schematic structural diagram of an end-to-end DASH system according to some embodiments of the present application;

FIG. 15 is a schematic structural diagram of a video track transmission system according to some embodiments of the present application;

FIG. 16 is a schematic diagram of a logical structure of an apparatus for presenting video information according to some embodiments of the present application; and

FIG. 17 is a schematic diagram of a hardware structure of a computer device according to some embodiments of the present application.

### DESCRIPTION OF EMBODIMENTS

The following clearly describes the technical solutions in the embodiments of the present application with reference to the accompanying drawings in the embodiments of the present application.

In November 2011, the MPEG organization approved the dynamic adaptive streaming over HTTP (DASH) standard. The DASH standard (which is referred to as the DASH technical specification below) is a technical specification for transmitting a media stream according to the HTTP protocol. The DASH technical specification mainly includes two parts: a media presentation description and a media file format.

The media file format is a type of file format. In DASH, a server prepares a plurality of versions of bitstreams for same video content, and each version of bitstream is referred to as a representation in the DASH standard. The representation is a set and encapsulation of one or more bitstreams in a transport format, and one representation includes one or more segments. Different versions of bitstreams may have different encoding parameters such as bitrates and resolutions. Each bitstream is divided into a plurality of small files, and each small file is referred to as a segment. When a client requests media segment data, switching may be performed between different media representations. The segment may be encapsulated in a format (an ISO BMFF (Base Media File Format)) in the ISO/IEC 14496-12 standard, or may be encapsulated in a format (MPEG2-TS) in ISO/IEC 13818-1.

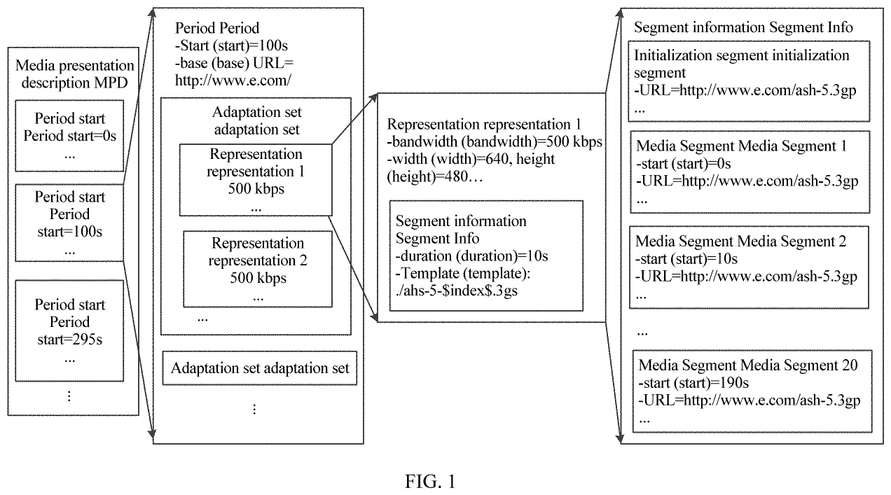

In the DASH standard, the media presentation description is referred to as an MPD, and the MPD may be an xml file, and information in the file is described in a hierarchical manner. As shown in FIG. 1, information at a previous level is completely inherited by a current level. Some media metadata is described in the file. The metadata may enable the client to understand media content information on the server and construct, by using the information, an http-URL for requesting a segment.

In the DASH standard, a media presentation is a set of structured data for presenting media content. The media presentation description is a file for normatively describing the media presentation, and is used to provide a streaming media service. In terms of a period, a group of consecutive periods form an entire media presentation, and the periods are continuous and non-overlapping. In the MPD, a representation is a set and encapsulation of description information of one or more bitstreams in a transport format, and one representation includes one or more segments. An adaptation set represents a set of a plurality of interchangeable encoding versions of a same media content component, and one adaptation set includes one or more representations. A subset is a combination of a group of adaptation sets, and when all the adaptation sets in the subset are played by using a player, corresponding media content may be obtained. Segment information is a media unit referenced by an HTTP uniform resource locator in the media presentation description. The segment information describes segments of video content data. The segments of the video content data may be stored in one file, or may be separately stored. In a possible manner, the MPD stores the segments of the video content data.

For technical concepts related to the MPEG-DASH technology in the present application, refer to related provisions in ISO/IEC 23009-1: Information technology-Dynamic adaptive streaming over HTTP (DASH)-Part 1: Media presentation description and segment formats, or refer to related provisions in a historical standard version, for example, ISO/IEC 23009-1: 2013 or ISO/IEC 23009-1: 2012.

A virtual reality technology is a computer simulation system in which a virtual world can be created and experienced. In the virtual reality technology, a simulated environment is created by using a computer, and the virtual reality technology is interactive system simulation featuring multi-source information fusion and three-dimensional dynamic visions and physical behavior, so that a user can be immersed in the environment. VR mainly includes a simulated environment, perception, a natural skill, a sensing device, and the like. The simulated environment is a computer-generated, real-time, dynamic, and three-dimensional realistic picture. The perception means that ideal VR should have all kinds of human perception. In addition to visual perception generated by using a computer graphics technology, perception such as an auditory sensation, a tactile sensation, a force sensation, and a motion sensation is also included, and even an olfactory sensation, a taste sensation, and the like are also included. This is also referred to as multi-perception. The natural skill is a head or eye movement of a person, a gesture, or another human behavior or action. The computer processes data suitable for an action of a participant, makes a response to an input of the user in real time, and separately feeds back the response to five sense organs of the user. The sensing device is a three-dimensional interactive device. When a VR video (or a 360-degree video, or an omnidirectional video) is presented on a head-mounted device and a handheld device, only a video picture corresponding to a user head orientation part and associated audio are presented.

A difference between a VR video and a normal video lies in that entire video content of the normal video is presented to a user while only a subset of the entire VR video is presented to the user (in VR typically only a subset of the entire video region represented by the video pictures).

In an existing standard, spatial information is described as follows: “The SRD scheme allows media presentation authors to express spatial relationships between spatial objects. A spatial object is defined as a spatial part of a content component (for example, a region of interest, or a tile) and represented by either an adaptation set or a sub-representation.”

The spatial information is a spatial relationship between spatial objects. The spatial object is defined as a spatial part of a content component, for example, an existing region of interest (ROI) and a tile. The spatial relationship may be described in an adaptation set and a sub-representation. In the existing standard, spatial information of a spatial object may be described in an MPD.

In the ISO/IEC 14496-12 (2012) standard document, a file includes many boxes and full boxes. Each box includes a header and data. A full box is an extension of a box. The header includes a length and a type of the entire box. When length=0, it means that the box is a last box in the file. When length=1, it means that more bits are needed to describe the length of the box. The data is actual data in the box, and may be pure data or more sub-boxes.

In the ISO/IEC 14496-12 (2012) standard document, a “tref box” is used to describe a relationship between tracks. For example, one MP4 file includes three video tracks whose IDs are 2, 3, and 4 and three audio tracks whose IDs are 6, 7, and 8. It may be specified in a tref box for the track 2 and the track 6 that the track 2 and the track 6 are bound for play.

In provisions of a current standard, for example, ISO/IEC 23000-20, an association type used for an association between a media content track and a metadata track is “cdsc”. For example, if an associated track is obtained through parsing in a video track, and an association type is “cdsc”, it indicates that the associated track is a metadata track used to describe the video track. However, in actual application, there are many types of metadata for describing media content, and different types of metadata can provide different use methods for a user. A client needs to parse all tracks included in a file, and then determines, based on an association type used for an association between a media content track and a metadata track, an attribute of a track associated with media content, to determine attributes of the video track and experience that can be provided by different attributes for a user. In other words, if an operation that can be performed by the client when a video track is presented needs to be determined, the operation can be determined only after all tracks in a file are parsed. Consequently, complexity of an implementation procedure of the client is increased.

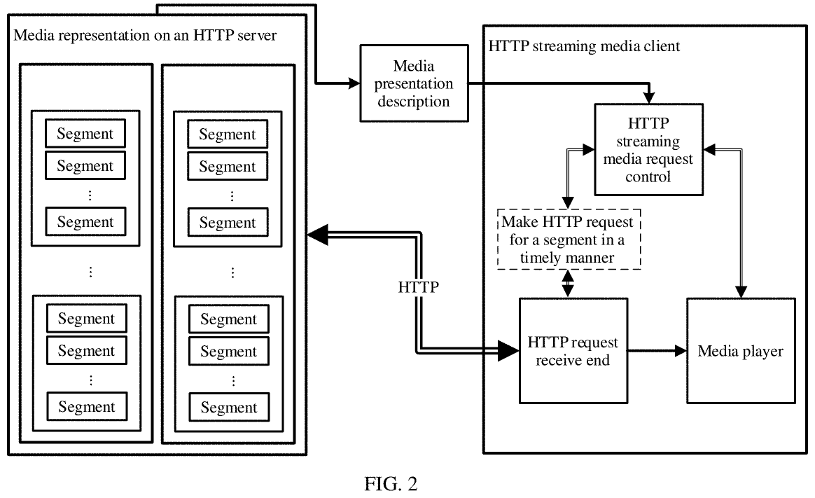

Currently, a DASH standard framework may be used in a client-orientated system-layer video streaming media transmission solution. FIG. 2 is a schematic diagram of a framework instance that is transmitted according to DASH standard and that is used for system-layer video streaming media transmission. The system-layer video streaming media transmission solution includes two data transmission processes: a process in which a server (for example, an HTTP server or a media content preparation server, which is referred to as a server below) generates video content data for video content, and responds to a request from a client, and a process in which the client (for example, an HTTP streaming media client) requests and obtains the video content data from the server. The video content data includes an MPD and a media bitstream (for example, a to-be-played video bitstream). The MPD on the server includes a plurality of representations, and each representation describes a plurality of segments. An HTTP streaming media request control module of the client obtains the MPD sent by the server, analyzes the MPD to determine information that is about each segment of a video bitstream and that is described in the MPD, and further determine a to-be-requested segment, sends an HTTP request for the corresponding segment to the server, and decodes and plays the segment by using a media player.

(1). In the process in which the server generates the video content data for the video content, the video content data generated by the server for the video content includes different versions of video bitstreams corresponding to same video content and MPDs of bitstreams. For example, the server generates a bitstream with a low resolution, a low bitrate, and a low frame rate (for example, a resolution of 360 p, a bitrate of 300 kbps, and a frame rate of 15 fps), a bitstream with an intermediate resolution, an intermediate bitrate, and a high frame rate (for example, a resolution of 720 p, a bitrate of 1200 kbps, and a frame rate of 25 fps), and a bitstream with a high resolution, a high bitrate, and a high frame rate (for example, a resolution of 1080 p, a bitrate of 3000 kbps, and a frame rate of 25 fps) for video content of a same episode of a TV series.

In addition, the server may further generate an MPD for the video content of the episode of the TV series. FIG. 1 is a schematic structural diagram of an MPD in the DASH standard in a system transmission solution. The MPD of the bitstream includes a plurality of periods. For example, a part, namely, period start=100s, in the MPD in FIG. 1 may include a plurality of adaptation sets, and each adaptation set may include a plurality of representations such as a representation 1 and a representation 2. Each representation describes one or more segments of the bitstream.

In an embodiment of the present application, each representation describes information about several segments in a time sequence, for example, an initialization segment, a media segment 1, a media segment 2, . . . , and a media segment 20. The representation may include segment information such as a play start moment, play duration, and a network storage address (for example, a network storage address represented in a form of a uniform resource locator (URL)).

(2). In the process in which the client requests and obtains the video content data from the server, when a user selects a video for play, the client obtains a corresponding MPD from the server based on the video content selected by the user. The client sends, to the server based on a network storage address of a bitstream segment described in the MPD, a request for downloading the bitstream segment corresponding to the network storage address, and the server sends the bitstream segment to the client according to the received request. After obtaining the bitstream segment sent by the server, the client may perform operations such as decoding and play by using the media player.

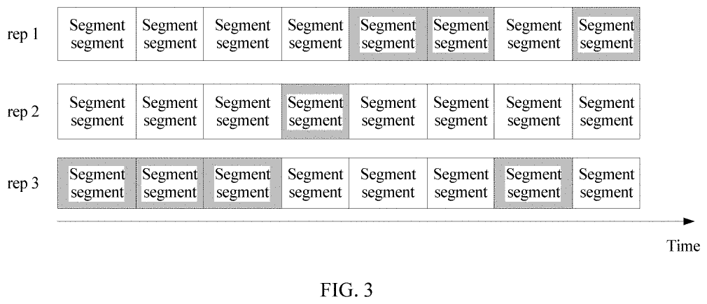

FIG. 3 is a schematic diagram of bitstream segment switching according to an embodiment of the present application. A server may prepare three pieces of bitstream data of different versions for same video content (such as a movie), and describe the three pieces of bitstream data of different versions by using three representations in an MPD. The three representations (referred to as a rep below) may be assumed as a rep 1, a rep 2, and a rep 3. The rep 1 is a high-definition video with a bitrate of 4 mbps (megabits per second), the rep 2 is a standard-definition video with a bitrate of 2 mbps, and the rep 3 is a normal video with a bitrate of 1 mbps. A segment in each rep includes a video bitstream in a time period, and segments included in different reps are aligned with each other in a same time period. To be specific, each rep describes segments in time periods in a time sequence, and segments in a same time period have a same length, so that switching may be performed between content of segments in different reps. As shown in the figure, a shaded segment in the figure is segment data that a client requests to play. The first three segments requested by the client are segments in the rep 3. When requesting a fourth segment, the client may request a fourth segment in the rep 2, and then may switch to the fourth segment in the rep 2 for play after a third segment in the rep 3 is played. A play end point (which may correspond to a play end moment in terms of time) of the third segment in the rep 3 is a play start point (which may correspond to a play start moment in terms of time) of the fourth segment, and is also a play start point of a fourth segment in the rep 2 or the rep 1, so that segments in different reps are aligned with each other. After requesting the fourth segment in the rep 2, the client switches to the rep 1 to request a fifth segment, a sixth segment, and the like in the rep 1. The client may subsequently switch to the rep 3 to request a seventh segment in the rep 3, and then switch to the rep 1 to request an eighth segment in the rep 1. Segments in each rep may be stored in one file in a head-to-tail connection manner, or may be separately stored as small files. The segment may be encapsulated in a format (an ISO BMFF) in the ISO/IEC 14496-12 standard, or may be encapsulated in a format (MPEG2-TS) in ISO/IEC 13818-1. This may be specifically determined based on an actual application scenario requirement, and is not limited herein.

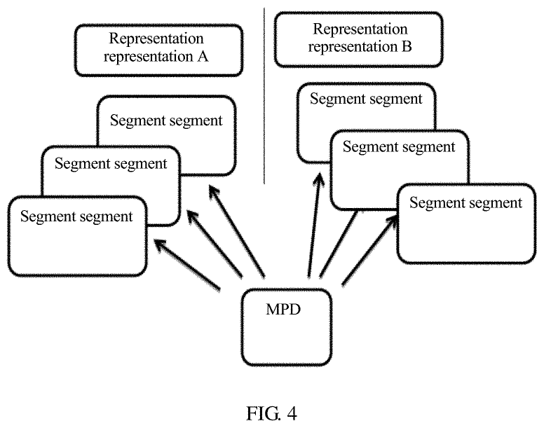

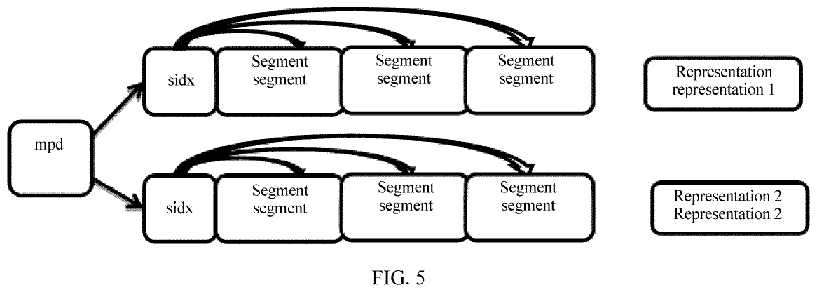

As mentioned in a DASH media file format, there are two segment storage manners. In one manner, all segments are separately stored, as shown in FIG. 4, and FIG. 4 is a schematic diagram of a storage manner of a segment in bitstream data. In the other manner, all segments in a same rep are stored in one file, as shown in FIG. 5, and FIG. 5 is another schematic diagram of a storage manner of a segment in bitstream data. As shown in FIG. 4, each of segments in a rep A is separately stored as one file, and each of segments in a rep B is also separately stored as one file. Correspondingly, in the storage manner shown in FIG. 4, a server may describe information such as a URL of each segment in a form of a template or a list in an MPD of a bitstream. As shown in FIG. 5, all segments in a rep 1 are stored as one file, and all segments in a rep 2 are stored as one file. Correspondingly, in the storage manner shown in FIG. 5, a server may describe information about each segment in an MPD of a bitstream by using an index segment (namely, sidx in FIG. 5). The index segment describes information such as a byte offset of each segment in a file storing the segment, a size of each segment, and duration, which is also referred to as a time length of each segment, of each segment.

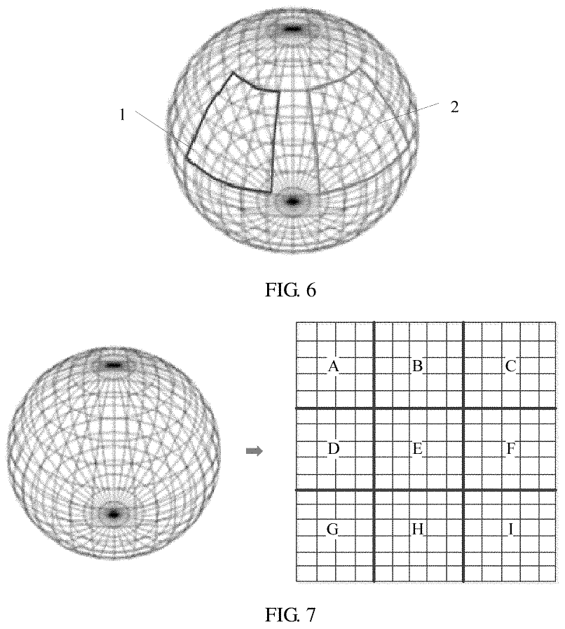

Currently, with increasing popularity of applications for viewing a VR video such as a 360-degree video, an increasing quantity of users participate in viewing a VR video with a large field of view. Although such a new video viewing application brings a new video viewing mode and visual experience to the users, a new technical challenge is also posed. In a process of viewing a video with a large field of view such as a 360-degree field of view (the 360-degree field of view is used as an example for description in the embodiments of the present application), a spatial region (the spatial region may also be referred to as a spatial object) of the VR video is 360-degree panoramic space (or referred to as omnidirectional space or a panoramic spatial object), and exceeds a normal human-eye visual range. Therefore, when viewing the video, a user changes a field of view (FOV) at any time. A viewed video picture changes with a field of view of the user, and therefore content presented in the video needs to change with the field of view of the user. FIG. 6 is a schematic diagram of a field of view corresponding to a field of view change. A block 1 and a block 2 are two different fields of view of the user. When viewing the video, the user may change the field of view for video viewing from the block 1 to the block 2 by performing an operation such as eye or head movement or picture switching of a video viewing device. A video picture viewed by the user when the field of view is the block 1 is a video picture presented at the moment in one or more spatial objects corresponding to the field of view. The field of view of the user is changed to the block 2 at a next moment. In this case, a video picture viewed by the user should also be changed into a video picture presented at the moment in a spatial object corresponding to the block 2.

In some feasible implementations, when a video picture with a large field of view of 360 degrees is output, a server may divide panoramic space (or referred to as a panoramic spatial object) in a 360-degree field of view range to obtain a plurality of spatial objects. Each spatial object corresponds to one sub-field of view of the user, and a plurality of sub-fields of view are spliced into a complete human-eye observation field of view. In other words, a human-eye field of view (referred to as a field of view below) may correspond to one or more spatial objects obtained through division. The spatial objects corresponding to the field of view are all spatial objects corresponding to content objects in a human-eye field of view range. The human-eye observation field of view may dynamically change, but the field of view range may be usually 120 degrees×120 degrees. A spatial object corresponding to a content object in the human-eye field of view range of 120 degrees×120 degrees may include one or more spatial objects obtained through division, for example, a field of view 1 corresponding to the block 1 in FIG. 6 and a field of view 2 corresponding to the block 2. Further, a client may obtain, by using an MPD, spatial information of a video bitstream prepared by the server for each spatial object, and then may request a video bitstream segment corresponding to one or more spatial objects from the server based on a field of view requirement in a time period, and output the corresponding spatial objects based on the field of view requirement. The client outputs, in a same time period, video bitstream segments corresponding to all spatial objects in the 360-degree field of view range, to output and display a complete video picture in the time period in the entire 360-degree panoramic space.

In specific implementation, when obtaining 360-degree spatial objects through division, the server may first map a sphere to a plane, and obtains the spatial objects through division on the plane. Specifically, the server may map the sphere to a longitude and latitude plan view in a longitude and latitude mapping manner. FIG. 7 is a schematic diagram of a spatial object according to an embodiment of the present application. The server may map the sphere to the longitude and latitude plan view, and divide the longitude and latitude plan view into a plurality of spatial objects such as a spatial object A to a spatial object I. Further, the server may alternatively map the sphere to a cube, and then unfold a plurality of surfaces of the cube to obtain a plan view, or may map the sphere to another polyhedron, and then unfold a plurality of surfaces of the polyhedron to obtain a plan view, or the like. The server may map the sphere to the plane in more mapping manners. This may be specifically determined based on an actual application scenario requirement, and is not limited herein. Description is provided below with reference to FIG. 7 by using the longitude and latitude mapping manner as an example. As shown in FIG. 7, after dividing panoramic space of the sphere into the plurality of spatial objects such as the spatial object A to the spatial object I, the server may prepare a group of DASH video bitstreams for each spatial object. Each spatial object corresponds to one group of DASH video bitstreams. When a client user changes a field of view for video viewing, the client may obtain, based on a new field of view selected by the user, a bitstream corresponding to a new spatial object, and then may present, in the new field of view, video content of the bitstream corresponding to the new spatial object. An information processing method and apparatus provided in the embodiments of the present application are described below with reference to FIG. 8 and FIG. 9.

The DASH standard is used in the system-layer video streaming media transmission solution. The client analyzes an MPD, requests video data from the server as needed, and receives the data sent by the server, to implement video data transmission.

In some embodiments, when producing a video, a video producer (referred to as an author below) may design a main plot line for video play based on a requirement of a story plot of the video. In a video play process, a user can learn of the story plot by viewing only a video picture corresponding to the main plot line, and may or may not view another video picture. Therefore, it can be learned that in the video play process, the client may play the video picture corresponding to the story plot, and may not present another video picture, to reduce video data transmission resources and storage space resources, and improve video data processing efficiency. After designing the main story plot, the author may design, based on the main plot line, a video picture that needs to be presented to the user at each play moment during video play, and the story plot of the main plot line may be obtained when video pictures at all the play moments are concatenated in a time sequence. The video picture that needs to be presented to the user at each play moment is a video picture presented in a spatial object corresponding to each play moment, namely, a video picture that needs to be presented in the spatial object at the moment. In specific implementation, a field of view corresponding to the video picture that needs to be presented at each play moment may be assumed as a field of view of the author, and a spatial object that presents a video picture in the field of view of the author may be assumed as a spatial object of the author. A bitstream corresponding to the spatial object in the field of view of the author may be assumed as a bitstream in the field of view of the author. The bitstream in the field of view of the author includes video frame data of a plurality of video frames (encoded data of the plurality of video frames). Each video frame may be presented as one picture, in other words, the bitstream in the field of view of the author corresponds to a plurality of pictures. In the video play process, a picture presented in the field of view of the author at each play moment is only a part of a panoramic picture (or referred to as a VR picture or an omnidirectional picture) that needs to be presented in the entire video. At different play moments, spatial information of spatial objects associated with pictures corresponding to the bitstream in the field of view of the author may be different or may be the same, in other words, spatial information of spatial objects associated with video data in the bitstream in the field of view of the author is different.

In some embodiments, after designing the field of view of the author at each play moment, the author prepares a corresponding bitstream for the field of view of the author at each play moment by using the server. The bitstream corresponding to the field of view of the author is assumed as a bitstream in the field of view of the author. The server encodes the bitstream in the field of view of the author, and transmits the encoded bitstream to the client. After decoding the bitstream in the field of view of the author, the client presents a story plot picture corresponding to the bitstream in the field of view of the author to the user. The server does not need to transmit a bitstream in a field of view (which is assumed as a non-author field of view, namely, a bitstream in a static field of view) other than the field of view of the author to the client, to reduce resources such as video data transmission bandwidth.

In some embodiments, a high-quality picture encoding manner, for example, high-resolution picture encoding such as encoding performed by using a small quantization parameter, is used for the field of view of the author, and a low-quality picture encoding manner, for example, low-resolution picture encoding such as encoding performed by using a large quantization parameter, is used for the non-author field of view, to reduce resources such as video data transmission bandwidth.

In some embodiments, a picture of a preset spatial object is presented in the field of view of the author based on the story plot designed by the author for the video, and spatial objects of the author at different play moments may be different or may be the same. Therefore, it can be learned that the field of view of the author is a field of view that constantly changes with the play moment, and the spatial object of the author is a dynamic spatial object whose location constantly changes, that is, not all locations of spatial objects of the author that correspond to all the play moments are the same in the panoramic space. Each spatial object shown in FIG. 7 is a spatial object obtained through division according to a preset rule, and is a spatial object whose relative location is fixed in the panoramic space. A spatial object of the author corresponding to any play moment is not necessarily one of fixed spatial objects shown in FIG. 7, but is a spatial object whose relative location constantly changes in the global space. Content that is presented in the video and that is obtained by the client from the server is concatenation in fields of view of the author, and does not include a spatial object corresponding to the non-author field of view. The bitstream in the field of view of the author includes only content of the spatial object of the author, and an MPD obtained from the server does not include spatial information of the spatial object of the author in the field of view of the author. In this case, the client can decode and present only the bitstream in the field of view of the author. When viewing the video, if the user changes a field of view to the non-author field of view, the client cannot present corresponding video content to the user.

In some embodiments, when generating a media presentation description, the server adds identification information to the media presentation description, to identify a bitstream that is of the video and that is in the field of view of the author, namely, the bitstream in the field of view of the author. In specific implementation, in some embodiments, the identification information is carried in attribute information that is carried in the media presentation description and that is of a bitstream set in which the bitstream in the field of view of the author is located. To be specific, in some embodiments, the identification information is carried in information about an adaptation set in the media presentation description, or the identification information is carried in information about a representation included in the media presentation description. Further, in some embodiments, the identification information is carried in information about a descriptor in the media presentation description. The client can quickly identify the bitstream in the field of view of the author and a bitstream in the non-author field of view by parsing the MPD to obtain an added syntax element in the MPD. If spatial information related to the bitstream in the field of view of the author is encapsulated in an independent metadata file, the client is able to obtain metadata of the spatial information based on a codec identifier by parsing the MPD, to obtain the spatial information through parsing.

In some embodiments, the server further adds spatial information of one or more spatial objects of the author to the bitstream in the field of view of the author. Each spatial object of the author corresponds to one or more pictures, that is, one or more pictures may be associated with a same spatial object, or each picture may be associated with one spatial object. In some embodiments, the server adds spatial information of each spatial object of the author to the bitstream in the field of view of the author, so that the spatial information can be used as a sample, and is independently encapsulated in a track or a file. Spatial information of a spatial object of the author is a spatial relationship between the spatial object of the author and a content component associated with the spatial object of the author, namely, a spatial relationship between the spatial object of the author and the panoramic space. To be specific, in some embodiments, space described by the spatial information of the spatial object of the author is a part of the panoramic space, for example, any spatial object in FIG. 7. In specific implementation, in some embodiments, for a DASH bitstream, the server adds the spatial information to a trun box or a tfhd box that is in a file format and that is included in a segment of the bitstream in the field of view of the author, to describe spatial information of a spatial object associated with each frame of picture corresponding to video frame data in the bitstream in the field of view of the author.

Further, because there may be same information in spatial information of spatial objects associated with all the frames of picture, repetition and redundancy exist in spatial information of a plurality of spatial objects of the author, affecting data transmission efficiency.

In the embodiments of the present application, a video file format provided in the DASH standard is modified, so as to lessen the repetition and redundancy existing in the spatial information of the plurality of spatial objects of the author.

In some embodiments, the file format modification is applied to a file format such as an ISO BMFF or MPEG2-TS. This may be specifically determined based on an actual application scenario requirement, and is not limited herein.

A spatial information obtaining method is provided in an embodiment of the present application, and, in various embodiments, is applied to the DASH field or to another streaming media field, for example, RTP protocol-based streaming media transmission. In various embodiments, the method is performed by a client, a terminal, user equipment, a computer device, or a network device such as a gateway or a proxy server.

Target spatial information of a target spatial object is obtained. It is assumed that the target spatial object is one of two spatial objects. The two spatial objects are associated with data of two pictures that is included in target video data. The target spatial information includes same-attribute spatial information. The same-attribute spatial information includes same information between respective spatial information of the two spatial objects. Spatial information of a spatial object other than the target spatial object in the two spatial objects includes the same-attribute spatial information.

In various embodiments, the target video data is a target video bitstream, or unencoded video data. When the target video data is the target video bitstream, the data of the two pictures is encoded data of the two pictures, in some embodiments. Further, in various embodiments, the target video bitstream is a bitstream in a field of view of an author or a bitstream in a non-author field of view.

In some embodiments, obtaining the target spatial information of the target spatial object icnludes receiving the target spatial information from a server.

In various embodiments, the two pictures are in a one-to-one correspondence with the two spatial objects, or one spatial object corresponds to two pictures.

Spatial information of a target spatial object is a spatial relationship between the target spatial object and a content component associated with the target spatial object, namely, a spatial relationship between the target spatial object and panoramic space. To be specific, in some embodiments, space described by the target spatial information of the target spatial object is a part of the panoramic space. In various embodiments, the target video data is the bitstream in the field of view of the author or the bitstream in the non-author field of view. The target spatial object may or may not be the spatial object of the author.

In some embodiments, the target spatial information further includes different-attribute spatial information of the target spatial object, the spatial information of the other spatial object further includes different-attribute spatial information of the other spatial object, and the different-attribute spatial information of the target spatial object is different from the different-attribute information of the other spatial object.

In some embodiments, the target spatial information includes location information of a central point of the target spatial object or location information of an upper-left point of the target spatial object. In some embodiments, the target spatial information further includes a width of the target spatial object and a height of the target spatial object.

When a coordinate system corresponding to the target spatial information is an angular coordinate system, the target spatial information is described by using a yaw angle, in some embodiments. When a coordinate system corresponding to the target spatial information is a pixel coordinate system, the target spatial information is described by using a spatial location in a longitude and latitude map or by using another geometric solid pattern, in some embodiments. This is not limited herein. The target spatial information is described by using the yaw angle, for example, a pitch angle θ, a yaw angle ψ, a roll angle Φ, a width used to represent an angle range, or a height used to represent an angle range. FIG. 8 is a schematic diagram of a relative location of a central point of a target spatial object in panoramic space. In FIG. 8, a point O is a sphere center corresponding to a spherical picture of a 360-degree VR panoramic video, and may be considered as a human-eye location when the VR panoramic picture is viewed. A point A is the central point of the target spatial object, C and F are edge points in the target spatial object that are connected through a line passing through the point A and that are along a lateral coordinate axis of the target spatial object, E and D are edge points in the target spatial object that are connected through a line passing through the point A and that are along a longitudinal coordinate axis of the target spatial object, B is a projected point of the point A in the equator along a spherical meridian, and I is a start coordinate point of the equator in a horizontal direction. The elements are explained as follows:

The pitch angle is a deflection angle, in a vertical direction, of a point that is of the panoramic spherical picture (namely, the global space) and to which a center location of a picture of the target spatial object is mapped, for example, Angle AOB in FIG. 8.

The yaw angle is a deflection angle, in a horizontal direction, of the point that is of the panoramic spherical picture and to which the center location of the picture of the target spatial object is mapped, for example, Angle IOB in FIG. 8.

The roll angle is a rotation angle in a direction of a line that connects the sphere center and the point that is of the panoramic spherical picture and to which the center location of the picture of the spatial object is mapped, for example, Angle DOB in FIG. 8.

The height used to represent an angle range (a height of the target spatial object in the angular coordinate system) is a field of view height that is of the picture of the target spatial object and that is in the panoramic spherical picture, and is represented by a maximum vertical field of view, for example, Angle DOE in FIG. 8. The width used to represent an angle range (a width of the target spatial object in the angular coordinate system) is a field of view width that is of the picture of the target spatial object and that is in the panoramic spherical picture, and is represented by a maximum horizontal field of view, for example, Angle COF in FIG. 8.

In some embodiments, the target spatial information includes location information of an upper-left point of the target spatial object and location information of a lower-right point of the target spatial object.

In some embodiments, when the target spatial object is not a rectangle, the target spatial information includes at least one of a shape type, a radius, or a circumference of the target spatial object.

In some embodiments, the target spatial information includes spatial rotation information of the target spatial object.

In some embodiments, the target spatial information is encapsulated in spatial information data or a spatial information track. In various embodiments, the spatial information data is a bitstream of the target video data, metadata of the target video data, or a file independent of the target video data. In some embodiments, the spatial information track is a track independent of the target video data.

In some embodiments, the spatial information data or the spatial information track further includes a spatial information type identifier configured to indicate a type of the same-attribute spatial information. The spatial information type identifier is used to indicate information that is in the target spatial information and that belongs to the same-attribute spatial information.

In some embodiments, when the spatial information type identifier indicates that the target spatial information includes no information that belongs to the same-attribute spatial information, the same-attribute spatial information includes a minimum value of the width of the target spatial object, a minimum value of the height of the target spatial object, a maximum value of the width of the target spatial object, and a maximum value of the height of the target spatial object.

In some embodiments, the spatial information type identifier and the same-attribute spatial information are encapsulated in a same box.

In a non-limiting specific implementation, when the target spatial information is encapsulated in a file (a spatial information file) independent of the target video data or a track (a spatial information track) independent of the target video data, the server adds the same-attribute spatial information to a 3dsc box in a file format, and adds the different-attribute spatial information of the target spatial object to an mdat box in the file format.

Example (Example 1) of adding the spatial information:

aligned(8) class 3DSphericalCoordinatesSampleEntry//same-attribute

spatial information

extends MetadataSampleEntry (‘3dsc’) {

unsigned int(2) regionType;//spatial information type identifier
if (regionType=0) {//the spatial information type identifier is 0

unsigned int(16) yaw;//yaw angle
unsigned int(16) pitch;//pitch angle

unsigned int(16) roll;//roll angle
unsigned int(16) reference_width;//width of the target spatial object
unsigned int(16) reference_height;//height of the target spatial object
}
If (regionType=1) {//the spatial information type identifier is 1
unsigned int(16) reference_width;//width of the target spatial object
unsigned int(16) reference_height;//height of the target spatial object
}
If (regionType=2) {//the spatial information type identifier is 2
unsigned int(16) min_reference_width;//minimum value of the width of

the target spatial object

unsigned int(16) min_reference_height;//minimum value of the height of

the target spatial object

unsigned int(16) max_reference_width;//maximum value of the width of

the target spatial object

unsigned int(16) max_reference_height;//maximum value of the height

of the target spatial object

}

}

aligned(8) class SphericalCoordinatesSample( ) {//different-attribute

spatial information of the target space object

if (regionType=1) {
unsigned int(16) yaw;
unsigned int(16) pitch;

unsigned int(16) roll;

}
If (regionType=2) {

unsigned int(16) yaw;
unsigned int(16) pitch;
unsigned int(16) roll;
unsigned int(16) reference_width;
unsigned int(16) reference_height;

}

}

In this non-limiting example, the same-attribute spatial information includes some but not all of the yaw, the pitch, the roll, the reference_width, and the reference_height. For example, the same-attribute spatial information does not include the roll. The roll may belong to the different-attribute spatial information of the target spatial object, or may not be included in the target spatial information. The spatial information type identifier regionType is further added to the 3dsc box. This example is an example in a case of the angular coordinate system. When the spatial information type identifier is 0, the spatial information type identifier is used to indicate that the information that is in the target spatial information and that belongs to the same-attribute spatial information is the location information of the central point of the target spatial object or the location information of the upper-left point of the target spatial object, the width of the target spatial object, and the height of the target spatial object. In this example, the location information is represented by the pitch angle θ, the yaw angle ψ, and the roll angle Φ, and the width and the height each may also be represented by an angle. In other words, when the spatial information type identifier is 0, the two spatial objects have both a same location and a same size (for example, a same width and a same height).

When the spatial information type identifier is 1, the spatial information type identifier is used to indicate that the information that is in the target spatial information and that belongs to the same-attribute spatial information is the width of the target spatial object and the height of the target spatial object. In other words, when the spatial information type identifier is 1, the two spatial objects have a same size (for example, a same width and a same height) but different locations.

When the spatial information type identifier is 2, the spatial information type identifier is used to indicate that the target spatial information includes no information that belongs to the same-attribute spatial information. In other words, when the spatial information type identifier is 2, the two spatial objects have different sizes and locations.

Correspondingly, when the spatial information type identifier is 0, it indicates that no different-attribute spatial information exists, in some embodiments. When the spatial information type identifier is 1, the spatial information type identifier further indicates that the different-attribute spatial information of the target spatial object is the location information of the central point of the target spatial object or the location information of the upper-left point of the target spatial object. When the spatial information type identifier is 2, the spatial information type identifier further indicates that the different-attribute spatial information of the target spatial object is the location information of the central point of the target spatial object or the location information of the upper-left point of the target spatial object, the width of the target spatial object, and the height of the target spatial object.

Example (Example 2) of adding the spatial information:

aligned(8) class 3DSphericalCoordinatesSampleEntry//same-attribute

spatial information

extends MetadataSampleEntry (‘3dsc’) {
unsigned int(2) regionType;//spatial information type identifier
if (regionType=0) {//the spatial information type identifier is 0

unsigned int(16) top_left_x;//horizontal coordinate of the upper-left point

unsigned int(16) top_left_y;//vertical coordinate of the upper-left point

unsigned int(16) reference_width;//width of the target spatial object
unsigned int(16) reference_height;//height of the target spatial object

}
If (regionType=1) {//the spatial information type identifier is 1

unsigned int(16) reference_width;//width of the target spatial object
unsigned int(16) reference_height;//height of the target spatial object

}
If (regionType=2) {//the spatial information type identifier is 2

unsigned int(16) min_reference_width;//minimum value of the width of

the target spatial object

unsigned int(16) min_reference_height;//minimum value of the height of

the target spatial object

unsigned int(16) max_reference_width;//maximum value of the width of

the target spatial object

unsigned int(16) max_reference_height;//maximum value of the height

of the target spatial object}

}

aligned(8) class SphericalCoordinatesSample( ) {//different-attribute

spatial information of the target space object

If (regionType=1) {

unsigned int( 16) top_left_x;//horizontal coordinate of the upper-left point

unsigned int(16) top_left_y;//vertical coordinate of the upper-left

point

}
If (regionType=2) {

unsigned int(16) top_left_x;//horizontal coordinate of the upper-left

point

unsigned int(16) top_left_y;//vertical coordinate of the upper-left

point

unsigned int(16) reference_width;//width of the target spatial object
unsigned int(16) reference_height;//height of the target spatial object

}

}

This example is a non-limiting example in a case of the pixel coordinate system. When the spatial information type identifier is 0, the spatial information type identifier is used to indicate that the information that is in the target spatial information and that belongs to the same-attribute spatial information is the location information of the upper-left point of the target spatial object, the width of the target spatial object, and the height of the target spatial object. In this example, the location information is represented by a horizontal coordinate in a unit of a pixel and a vertical coordinate in a unit of a pixel, and the width and the height each may also be represented in a unit of a pixel. The horizontal coordinate and the vertical coordinate may be coordinates of a location point in the longitude and latitude plan view in FIG. 7, or may be coordinates of a location point in the panoramic space (or a panoramic spatial object). In other words, when the spatial information type identifier is 0, the two spatial objects have both a same location and a same size. It should be noted that the location information of the upper-left point of the target spatial object may be replaced with the location information of the central point of the target spatial object.

When the spatial information type identifier is 1, the spatial information type identifier is used to indicate that the information that is in the target spatial information and that belongs to the same-attribute spatial information is the width of the target spatial object and the height of the target spatial object. In other words, when the spatial information type identifier is 1, the two spatial objects have a same size but different locations.

When the spatial information type identifier is 2, the spatial information type identifier is used to indicate that the target spatial information includes no information that belongs to the same-attribute spatial information. In other words, when the spatial information type identifier is 2, the two spatial objects have different sizes and locations.

Correspondingly, when the spatial information type identifier is 0, it indicates that no different-attribute spatial information exists, in some embodiments. When the spatial information type identifier is 1, the spatial information type identifier further indicates that the different-attribute spatial information of the target spatial object is the location information of the upper-left point of the target spatial object. When the spatial information type identifier is 2, the spatial information type identifier further indicates that the different-attribute spatial information of the target spatial object is the location information of the upper-left point of the target spatial object, the width of the target spatial object, and the height of the target spatial object. It should be noted that the location information of the upper-left point of the target spatial object may be replaced with the location information of the central point of the target spatial object.

Example (Example 3) of adding the spatial information:

aligned(8) class 3DSphericalCoordinatesSampleEntry//same-attribute

spatial information

extends MetadataSampleEntry (‘3dsc’) {
unsigned int(2) regionType;//spatial information type identifier
if (regionType=0) {//the spatial information type identifier is 0

unsigned int(16) top_left_x;//horizontal coordinate of the upper-left point

unsigned int(16) top_left_y;//vertical coordinate of the upper-left point

unsigned int(16) down_right_x;//horizontal coordinate of the lower-right

point

unsigned int(16) down_right_y;//vertical coordinate of the lower-right

point

}
If (regionType=1) {//the spatial information type identifier is 1

unsigned int(16) down_right_x;//horizontal coordinate of the

lower-right point

unsigned int(16) down_right_y;//vertical coordinate of the

lower-right point

}
If (regionType=2) {//the spatial information type identifier is 2

unsigned int(16) min_reference_width;//minimum value of the width of

the target spatial object

unsigned int(16) min_reference_height;//minimum value of the height of

the target spatial object

unsigned int(16) max_reference_width;//maximum value of the width of

the target spatial object

unsigned int(16) max_reference_height;//maximum value of the height

of the target spatial object}

}

aligned(8) class SphericalCoordinatesSample( ) {//different-attribute

spatial information of the target space object

If (regionType=1) {
unsigned int(16) top_left_x;//horizontal coordinate of the upper-left point

unsigned int(16) top_left_y;//vertical coordinate of the upper-left

point

}
If (regionType=2) {

unsigned int(16) top_left_x;//horizontal coordinate of the upper-left

point

unsigned int(16) top_left_y;//vertical coordinate of the upper-left

point

unsigned int(16) down_right_x;//horizontal coordinate of the

lower-right point

unsigned int(16) down_right_y;//vertical coordinate of the

lower-right point

}

}

This example is a non-limiting example in a case of the pixel coordinate system. When the spatial information type identifier is 0, the spatial information type identifier is used to indicate that the information that is in the target spatial information and that belongs to the same-attribute spatial information is the location information of the upper-left point of the target spatial object and the location information of the lower-right point of the target spatial object. In this example, the location information is represented by a horizontal coordinate in a unit of a pixel and a vertical coordinate in a unit of a pixel. The horizontal coordinate and the vertical coordinate may be coordinates of a location point in the longitude and latitude plan view in FIG. 7, or may be coordinates of a location point in the panoramic space (or a panoramic spatial object). In other words, when the spatial information type identifier is 0, the two spatial objects have both a same location and a same size. It should be noted that the location information of the lower-right point of the target spatial object may be replaced with the height and the width of the target spatial object.

When the spatial information type identifier is 1, the spatial information type identifier is used to indicate that the information that is in the target spatial information and that belongs to the same-attribute spatial information is the location information of the lower-right point of the target spatial object. In other words, when the spatial information type identifier is 1, the two spatial objects have a same size but different locations. It should be noted that the location information of the lower-right point of the target spatial object may be replaced with the height and the width of the target spatial object.

When the spatial information type identifier is 2, the spatial information type identifier is used to indicate that the target spatial information includes no information that belongs to the same-attribute spatial information. In other words, when the spatial information type identifier is 2, the two spatial objects have different sizes and locations.

Correspondingly, when the spatial information type identifier is 0, it indicates that no different-attribute spatial information exists, in some embodiments. When the spatial information type identifier is 1, the spatial information type identifier further indicates that the different-attribute spatial information of the target spatial object is the location information of the upper-left point of the target spatial object. When the spatial information type identifier is 2, the spatial information type identifier further indicates that the different-attribute spatial information of the target spatial object is the location information of the upper-left point of the target spatial object and the location information of the lower-right point of the target spatial object. It should be noted that the location information of the lower-right point of the target spatial object may be replaced with the height and the width of the target spatial object.

In some embodiments, the spatial information data or the spatial information track further includes a coordinate system identifier used to indicate the coordinate system corresponding to the target spatial information, and the coordinate system is a pixel coordinate system or an angular coordinate system.

In some embodiments, the coordinate system identifier and the same-attribute spatial information are encapsulated in a same box.

In a non-limiting example of a specific implementation, when the target spatial information is encapsulated in a file (a spatial information file) independent of the target video data or a track (a spatial information track) independent of the target video data, the server adds the coordinate system identifier to a 3dsc box in a file format.

Example (Example 4) of adding the coordinate system identifier:

aligned(8) class 3DSphericalCoordinatesSampleEntry//same-attribute

spatial information

extends MetadataSampleEntry (‘3dsc’) {

...
unsigned int(2) Coordinate_system;//coordinate system identifier
...
}

In this example, when the coordinate system identifier Coordinate_system is 0, the coordinate system is an angular coordinate system, or when the coordinate system identifier is 1, the coordinate system is a pixel coordinate system.

In some embodiments, the spatial information data or the spatial information track further includes a spatial rotation information identifier, and the spatial rotation information identifier is used to indicate whether the target spatial information includes the spatial rotation information of the target spatial object.

In various embodiments, the spatial rotation information identifier and the same-attribute spatial information are encapsulated in a same box (for example, a 3dsc box), or the spatial rotation information identifier and the different-attribute spatial information of the target spatial object are encapsulated in a same box (for example, an mdat box). Specifically, when the spatial rotation information identifier and the different-attribute spatial information of the target spatial object are encapsulated in a same box, when the spatial rotation information identifier indicates that the target spatial information includes the spatial rotation information of the target spatial object, the different-attribute spatial information of the target spatial object includes the spatial rotation information, in some embodiments.

In a non-limiting example of a specific implementation, the server encapsulates the spatial rotation information identifier and the different-attribute spatial information of the target spatial object in a same box (for example, an mdat box). Further, in some embodiments, the server encapsulates the spatial rotation information identifier and the different-attribute spatial information of the target spatial object in a same sample in the same box. Different-attribute information corresponding to one spatial object is encapsulated in one sample, in some embodiments.

Example (Example 5) of adding the spatial rotation information identifier:

aligned(8) class SphericalCoordinatesSample( ) {
...

unsigned int(1) rotation_flag;//spatial rotation information identifier,

where 0 indicates that there is no rotation, and 1 indicates that there is
rotation

if (rotation_flag=1)
{
unsigned int(16) rotation_degree;//spatial rotation information of the

target spatial object

}
...
}

In some embodiments, the same-attribute spatial information and the different-attribute spatial information of the target spatial object are encapsulated in metadata (track metadata) of spatial information of a video, for example, a same box such as a trun box, a tfhd box, or a new box.

Example (Example 6) of adding the spatial information:

syntax (syntax) of the trun box, the tfhd box, or the new box

unsigned int(2) regionType;//spatial information type identifier
if (regionType=0) {//the spatial information type identifier is 0

...//the same-attribute spatial information is the same as the same-attribute

spatial information existing when the spatial information type identifier is 0 in the
foregoing embodiment

}
If (regionType=1) {//the spatial information type identifier is 1

...//the same-attribute spatial information is the same as the

same-attribute spatial information existing when the spatial information type identifier
is 1 in the foregoing embodiment

}
If (regionType=2) {//the spatial information type identifier is 2

...//the same-attribute spatial information is the same as the same-attribute

spatial information existing when the spatial information type identifier is 2 in the
foregoing embodiment

}
unsigned int(32) samplecount;//quantity of samples
for (i=1; i<samplecount; i++)

If (regionType=1) {//the spatial information type identifier is 1

...//the different-attribute spatial information is the same as the

different-attribute spatial information that is of the target spatial object and that exists
when the spatial information type identifier is 1 in the foregoing embodiment

}
If (regionType=2) {//the spatial information type identifier is 2

...//the different-attribute spatial information is the same as the

different-attribute spatial information that is of the target spatial object and that exists
when the spatial information type identifier is 2 in the foregoing embodiment

}
}

One piece of spatial information of one spatial object is one sample, the quantity of samples is used to indicate a quantity of spatial objects, and each spatial object corresponds to one group of different-attribute spatial information. An implementation of the spatial information obtaining method provided in this embodiment of the present application includes the following steps:

1. A spatial information file, a spatial information track (the spatial information may be referred to as timed metadata), or spatial information metadata of a video (or referred to as metadata of the target video data) is obtained.

2. The spatial information file or the spatial information track is parsed.

3. A box (spatial information description box) whose tag is 3dsc is obtained through parsing, then the spatial information type identifier is parsed. The spatial information type identifier is optionally used to indicate spatial object types of the two spatial objects. Optionally, the spatial object type includes but is not limited to a spatial object whose location and size remain unchanged, a spatial object whose location changes and whose size remains unchanged, a spatial object whose location remains unchanged and whose size changes, and a spatial object whose location and size both change.

4. If a spatial object type obtained through parsing is a spatial object whose location and size remain unchanged, the same-attribute spatial information obtained through parsing in the 3dsc box is optionally used as the target spatial information, where the spatial object whose location and size remain unchanged means that a spatial location of the spatial object and a spatial size of the spatial object remain unchanged. The spatial object type indicates that all spatial information of the two spatial objects is the same, and a value of the spatial information is the same as that of the same-attribute spatial information obtained through parsing. In a case of this type of same-attribute spatial information, in subsequent parsing, a box in which the different-attribute spatial information of the target spatial object is located does not need to be parsed.

5. If a spatial object type obtained through parsing is a spatial object whose location changes and whose size remains unchanged, the same-attribute spatial information in the 3dsc box carries size information of the spatial object, for example, a height and a width of the spatial object. In this case, information carried in the different-attribute spatial information that is of the target spatial object and that is obtained through subsequent parsing is location information of each spatial object.

6. If a spatial object type obtained through parsing is a spatial object whose location and size both change, information carried in the different-attribute spatial information that is of the target spatial object and that is obtained through subsequent parsing is location information (for example, location information of a central point) of each spatial object and size information of the spatial object, for example, a height and a width of the spatial object.

7. After the target spatial information is obtained through parsing, a to-be-presented content object is selected from an obtained VR video based on a spatial object (the target spatial object) described in the target spatial information, or video data corresponding to a spatial object described in the target spatial information is requested to be decoded and presented, or a location of currently viewed video content in VR video space (or referred to as panoramic space) is determined based on the target spatial information.

In some embodiments, a manner of carrying the spatial information is described by adding a carrying manner identifier (carryType) to an MPD. For example, the spatial information is carried in a spatial information file, a spatial information track, or metadata of the target video data.

A specific MPD example is as follows:

The spatial information is carried in the metadata of the target video data (Example 7):

<?xml version=“1.0” encoding=“UTF-8”?>

<MPD
xmlns=“urn:mpeg:dash:schema:mpd:2011”
type=“static”
mediaPresentationDuration=“PT10S”
minBufferTime=“PT1S”
profiles=“urn:mpeg:dash:profile:isoff-on-demand:2011”>
<Period>

<!—the spatial information is carried in the metadata of the target video

data-->

<AdaptationSet segmentAlignment=“true” subsegmentAlignment=“true”

subsegmentStartsWithSAP=“1”>

| <EssentialProperty schemeIdUri=“urn:mpeg:dash:xxx:2016” | | |
|---|---|---|
| value=“1, 0”> | | |
| Representation | id=“zoomed” | mimeType=“video/mp4” |

codecs=“avc1.42c01e” bandwidth=“5000000” width=“1920” height=“1080”>

<BaseURL> video.mp4</BaseURL>
</Representation>

</AdaptationSet>
</Period>
</MPD>

In this example, value=“1, 0”, where 1 is a source identifier, and 0 indicates that the spatial information is carried in metadata (or referred to as the metadata of the target video data) in a track of the target video data.

The spatial information is carried in the spatial information track (Example 8):

<?xml version=“1.0” encoding=“UTF-8”?>

<MPD
xmlns=“urn:mpeg:dash:schema:mpd:2011”
type=“static”
mediaPresentationDuration=“PT10S”
minBufferTime=“PT1S”
profiles=“urn:mpeg:dash:profile:isoff-on-demand:2011”>
<Period>

<!—the spatial information is carried in the spatial information track, and

the spatial information track and the target video data are in a same file-->

<AdaptationSet segmentAlignment=“true” subsegmentAlignment=“true”

subsegmentStartsWithSAP=“1”>

| <EssentialProperty schemeIdUri=“urn:mpeg:dash:xxx:2016” | | |
|---|---|---|
| value=“1, 1”/> | | |
| Representation | id=“zoomed” | mimeType=“video/mp4” |

codecs=“avc1.42c01e” bandwidth=“5000000” width=“1920” height=“1080”>

<BaseURL>video.mp4</BaseURL>
</Representation>

</AdaptationSet>
</Period>
</MPD>

In this example, value=“1, 1”, where 1 is a source identifier, and 1 indicates that the spatial information is carried in an independent spatial information track.

The spatial information is carried in an independent spatial information file (Example 9):

<?xml version=“1.0” encoding=“UTF-8”?>

<MPD
xmlns=“urn:mpeg:dash:schema:mpd:2011”
type=“static”
mediaPresentationDuration=“PT10S”
minBufferTime=“PT1S”
profiles=“urn:mpeg:dash:profile:isoff-on-demand:2011”>
<Period>

<!—the spatial information is carried in the independent spatial

information file-->

<AdaptationSet segmentAlignment=“true” subsegmentAlignment=“true”

subsegmentStartsWithSAP=“1”>

| <EssentialProperty schemeIdUri=“urn:mpeg:dash:xxx:2016” | | |
|---|---|---|
| value=“1, 2”/> | | |
| Representation | id=“zoomed” | mimeType=“video/mp4” |

codecs=“avc1.42c01e” bandwidth=“5000000” width=“1920” height=“1080”>

<BaseURL>video.mp4</BaseURL>
</Representation>

</AdaptationSet>

<!—spatial information file-->
<AdaptationSet segmentAlignment=“true” subsegmentAlignment=“true”

subsegmentStartsWithSAP=“1”>

| | | |
|---|---|---|
| Representation | id=“roi-coordinates” | associationId=“zoomed” |

associationType=“cdsc” codecs=“2dcc” bandwidth=“100”>

<BaseURL>roi_coordinates.mp4</BaseURL>
</Representation>

</AdaptationSet>

</Period>

</MPD>

In this example, value=“1, 2”, where 1 is a source identifier, and 2 indicates that the spatial information is carried in the independent spatial information file. A target video representation (or referred to as a target video bitstream) associated with the spatial information file is represented by associationId=“zoomed”, and the spatial information file is associated with a target video representation whose representation id is “zoomed”.

In some embodiments, the client obtains, by parsing the MPD, the manner of carrying the spatial information, to obtain the spatial information based on the carrying manner.

In some embodiments, the spatial information data or the spatial information track further includes a width and/or height type identifier used to indicate the target spatial object. In various embodiments, the width and/or height type identifier is used to indicate a coordinate system used to describe the width and/or height of the target spatial object, or the width and/or height type identifier is used to indicate a coordinate system used to describe an edge of the target spatial object. The width and/or height type identifier may be one identifier, or may include a width type identifier and a height type identifier.

In various embodiments, the width and/or height type identifier and the same-attribute spatial information are encapsulated in a same box (for example, a 3dsc box), or the width and/or height type identifier and the different-attribute spatial information of the target spatial object are encapsulated in a same box (for example, an mdat box).

In a non-limiting example of a specific implementation, the server encapsulates the width and/or height type identifier and the same-attribute spatial information in a same box (for example, a 3dsc box). Further, when the target spatial information is encapsulated in a file (a spatial information file) independent of the target video data or a track (a spatial information track) independent of the target video data, the server adds the width and/or height type identifier to the 3dsc box, in some embodiments.

Example (Example 10) of adding the width and/or height type identifier:

aligned(8) class 3DSphericalCoordinatesSampleEntry//same-attribute

spatial information

extends MetadataSampleEntry (‘3dsc’) {

...
unsigned int(2) edge_type;//width and/or height type identifier
...
}

In some embodiments, the same-attribute spatial information and the different-attribute spatial information of the target spatial object are encapsulated in metadata (track metadata) of spatial information of a video, for example, a same box such as a trun box, a tfhd box, or a new box.

Example (Example 11) of adding the spatial information:

syntax (syntax) of the trun box, the tfhd box, or the new box {
...

unsigned int(2) edge_type;//width and/or height type identifier

...
}

In this example, when the width and/or height type identifier is 0, the coordinate system used to describe the width and the height of the target spatial object is shown in FIG. 9. A shaded part of a sphere is the target spatial object, and vertices of four corners of the target spatial object are B, E, G, and I. In FIG. 9, O is a sphere center corresponding to a spherical picture of a 360-degree VR panoramic video, and the vertices B, E, G, and I are points that are on the sphere and at which circles that pass through the sphere center (the sphere center O is used as a center of the circle, and a radius of the circle is a radius of the sphere corresponding to the spherical picture of the 360-degree VR panoramic video, the circle passes through a z-axis, and there are two such circles with one passing through points B, A, I, and O and the other one passing through points E, F, G, and O) intersect with circles parallel to an x-axis and a y-axis (the sphere center O is not used as a center of the circle, there are two such circles with one passing through points B, D, and E and the other one passing through points I, H, and G, and the two circles are parallel to each other). C is the central point of the target spatial object, an angle corresponding to an edge DH represents the height of the target spatial object, an angle corresponding to an edge AF represents the width of the target spatial object, and the edge DH and the edge AF pass through the point C. An edge BI, an edge EG, and the edge DH correspond to a same angle, and an edge BE, an edge IG, and the edge AF correspond to a same angle. A vertex of an angle corresponding to the edge BE is J, and J is a point at which the z-axis intersects with the circle that is in the foregoing circles and on which the points B, D, and E are located. Correspondingly, a vertex of an angle corresponding to the edge IG is a point at which the z-axis intersects with the circle that is in the foregoing circles and on which the points I, H, and G are located. A vertex of an angle corresponding to the edge AF is the point O, and a vertex of each of angles corresponding to the edge BI, the edge EG, and the edge DH is also the point O.

It should be noted that the foregoing is merely an example. In various embodiments, the target spatial object is obtained when two circles that pass through the x-axis intersect with two circles that are parallel to the y-axis and the z-axis and that do not pass through the sphere center, or the target spatial object is obtained when two circles that pass through the y-axis intersect with two circles that are parallel to the x-axis and the z-axis and that do not pass through the sphere center.

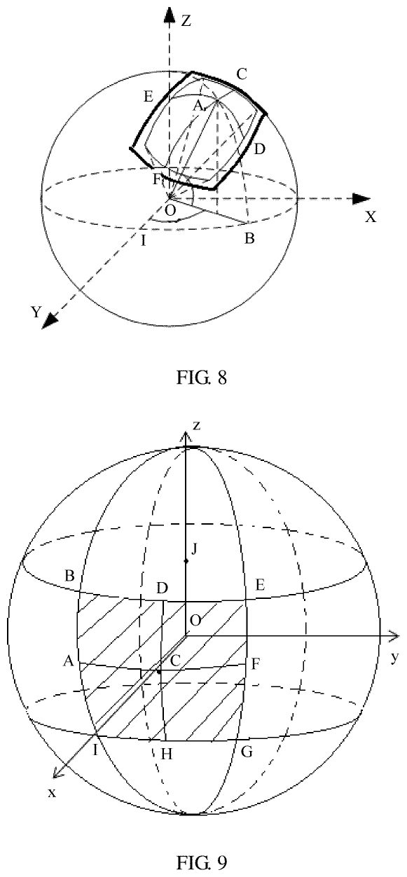

When the width and/or height type identifier is 1, the coordinate system used to describe the width and the height of the target spatial object is shown in FIG. 10. A shaded part of a sphere is the target spatial object, and vertices of four corners of the target spatial object are B, E, G, and I. In FIG. 10, O is a sphere center corresponding to a spherical picture of a 360-degree VR panoramic video, and the vertices B, E, G, and I are points that are on the sphere and at which circles that pass through a z-axis (the sphere center O is used as a center of the circle, a radius of the circle is a radius of the sphere corresponding to the spherical picture of the 360-degree VR panoramic video, and there are two such circles with one passing through points B, A, and I and the other one passing through points E, F, and G) intersect with circles that pass through a y-axis (the sphere center O is used as a center of the circle, a radius of the circle is the radius of the sphere corresponding to the spherical picture of the 360-degree VR panoramic video, and there are two such circles with one passing through points B, D, and E and the other one passing through points I, H, and G). C is the central point of the target spatial object, an angle corresponding to an edge DH represents the height of the target spatial object, an angle corresponding to an edge AF represents the width of the target spatial object, and the edge DH and the edge AF pass through the point C. An edge BI, an edge EG, and the edge DH correspond to a same angle, and an edge BE, an edge IG, and the edge AF correspond to a same angle. A vertex of an angle corresponding to the edge BE is a point J, and the point J is a point at which the z-axis intersects with a circle that passes through the points B and E and that is parallel to an x-axis and the y-axis. A vertex of an angle corresponding to the edge IG is a point at which the z-axis intersects with a circle that passes through the points I and G and that is parallel to the x-axis and the y-axis. A vertex of an angle corresponding to the edge AF is the point O. A vertex of an angle corresponding to the edge BI is a point L, and the point L is a point at which the y-axis intersects with a circle that passes through the points B and I and that is parallel to the z-axis and the x-axis. A vertex of an angle corresponding to the edge EG is a point at which the y-axis intersects with a circle that passes through the points E and G and that is parallel to the z-axis and the x-axis. A vertex of an angle corresponding to the edge DH is also the point O.

It should be noted that the foregoing is merely an example. In various embodiments, the target spatial object is obtained when two circles that pass through the x-axis intersect with two circles that pass through the z-axis, or the target spatial object is obtained when two circles that pass through the x-axis intersect with two circles that pass through the y-axis.

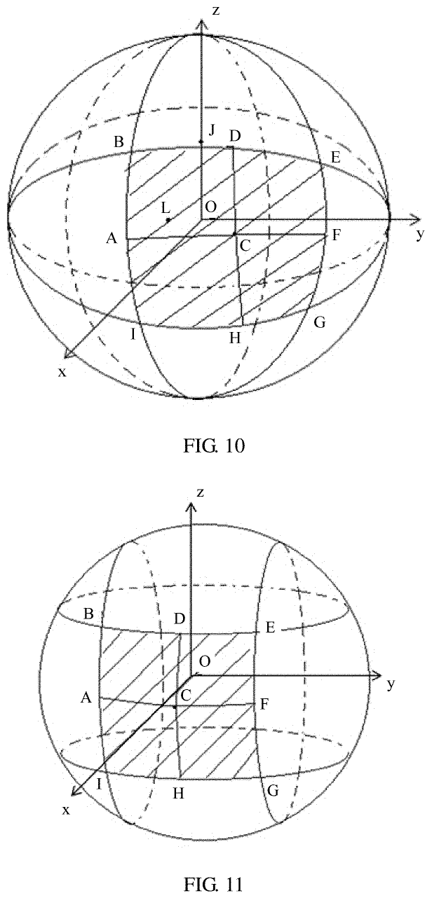

When the width and/or height type identifier is 2, the coordinate system used to describe the width and the height of the target spatial object is shown in FIG. 11. A shaded part of a sphere is the target spatial object, and vertices of four corners of the target spatial object are B, E, G, and I. In FIG. 11, O is a sphere center corresponding to a spherical picture of a 360-degree VR panoramic video, and the vertices B, E, G, and I are points that are on the sphere and at which circles parallel to an x-axis and a z-axis (the sphere center O is not used as a center of the circle, there are two such circles with one passing through points B, A, and I and the other one passing through points E, F, and G, and the two circles are parallel to each other) intersect with circles parallel to the x-axis and a y-axis (the sphere center O is not used as a center of the circle, there are two such circles with one passing through points B, D, and E and the other one passing through points I, H, and G, and the two circles are parallel to each other). C is the central point of the target spatial object, an angle corresponding to an edge DH represents the height of the target spatial object, an angle corresponding to an edge AF represents the width of the target spatial object, and the edge DH and the edge AF pass through the point C. An edge BI, an edge EG, and the edge DH correspond to a same angle, and an edge BE, an edge IG, and the edge AF correspond to a same angle. A vertex of each of angles corresponding to the edge BE, the edge IG, and the edge AF is the point O, and a vertex of each of angles corresponding to the edge BI, the edge EG, and the edge DH is also the point O.

It should be noted that the foregoing is merely an example. In various embodiments, the target spatial object is obtained when two circles that are parallel to the y-axis and the z-axis and that do not pass through the sphere center intersect with two circles that are parallel to the y-axis and the x-axis and that do not pass through the sphere center, or the target spatial object is obtained when two circles that are parallel to the y-axis and the z-axis and that do not pass through the sphere center intersect with two circles that are parallel to the z-axis and the x-axis and that do not pass through the sphere center.

A manner of obtaining the point J and the point L in FIG. 10 is the same as a manner of obtaining the point J in FIG. 9. The vertex of the angle corresponding to the edge BE is the point J, and the vertex of the angle corresponding to the edge BI is the point L. In FIG. 11, each of the vertices corresponding to the edge BE and the edge BI is the point O.

In some embodiments, the same-attribute spatial information and the different-attribute spatial information of the target spatial object further include description information of the target spatial object. For example, the description information is used to describe the target spatial object as a field of view region (for example, the target spatial object may be a spatial object corresponding to a bitstream in a field of view) or a region of interest, or the description information is used to describe quality information of the target spatial object. In various embodiments, the description information is added to syntax of the 3dsc box or the syntax of the trun box, the tfhd box, or the new box in the foregoing embodiment, or the description information (content_type) is added to SphericalCoordinatesSample, to implement one or more of the following functions: describing the target spatial object as a field of view region, describing the target spatial object as a region of interest, or describing the quality information of the target spatial object.

In anon-limiting example of an implementation of this embodiment of the present application, the quality information is described by using qualitybox. In various embodiments, the box is a sample entry box or a sample box. A non-limiting example of specific syntax and semantic description follows:

Manner 1: (Example 12)

aligned(8) class qualitybox {

unsigned int(1) quality_ranking_ROI;

unsigned int(1) quality_ranking_background;

}

In some embodiments, a perimeter of an ROI is a background of a picture, quality_ranking_ROI represents a quality rank of the ROI, and quality_ranking_back represents a quality rank of the perimeter of the ROI.

Manner 2: (Example 13):

aligned(8) class {

unsigned int(1) quality_ranking_dif;

}

The parameter quality_ranking_dif represents a quality rank difference between quality of an ROI and that of a perimeter (or a background) of the ROI, or quality_ranking_dif represents a difference between quality of the ROI and a specified value. The specified value may be described in an MPD, or the specified value may be described in another location. For example, defaultrank (default quality) is added to the box to include the specified value. When quality_ranking_dif>0, it indicates that the quality of the ROI is higher than the quality of the perimeter, when quality_ranking_dif<0, it indicates that the quality of the ROI is lower than the quality of the perimeter, or when quality_ranking_dif=0, it indicates that the quality of the ROI is the same as the quality of the perimeter.

Manner 3: (Example 14):

aligned(8) class qualitybox {

unsigned int(1) quality_type;
unsigned int(1) quality_ranking;

}

The parameter quality_type represents a quality type, a value 0 of quality_type represents quality of an ROI, and a value 1 of quality_type represents background quality, in some embodiments. In some embodiments, a value of quality_type is represented in another similar manner. The parameter quality_ranking represents a quality rank.

Manner 4: (Example 15):

aligned(8) class qualitybox {

ROiregionstruct;

unsigned int(1) quality_ranking_ROI
unsigned int(8) num_regions
for (i=0; i < num_regions; i++) {

unsigned int(8) region_dif;

unsigned int(1) quality_ranking_dif;

}
}

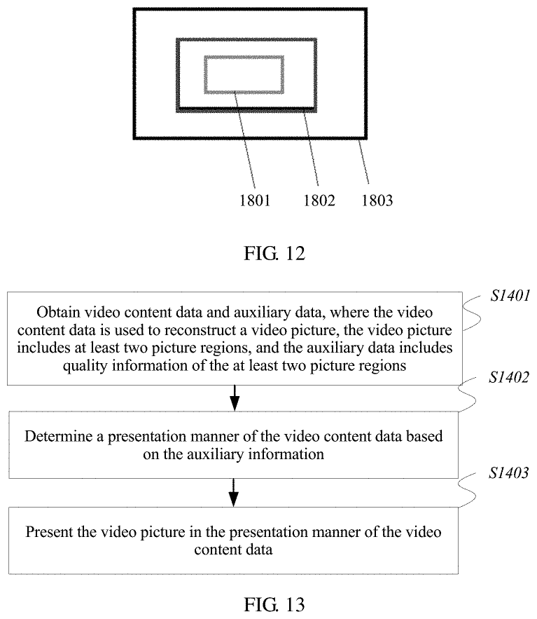

For example, in FIG. 12, ROiregionstruct describes region information of a region 1801. In various embodiments, the region information is specific region information as described in an existing standard, or is a track ID of a timed metadata track of the ROI. In some embodiments, the parameter quality_ranking_ROI represents a quality rank of the region 1801. The parameter num_regions represents a quantity of peripheral ring regions. The parameter region_dif represents a width of the ring region (namely, a difference between a region 1802 and the region 1801), or a height difference or a horizontal difference between a region 1802 and the region 1801. The difference may be a difference in a case of a spherical coordinate system, or may be a difference in a case of a 2D coordinate system. The parameter quality_ranking_dif represents a quality rank of the ring region or a quality rank difference with an adjacent ring region. The quality rank difference with the adjacent ring region is, for example, a quality rank difference between the region 1802 and the region 1801, or a quality rank difference between the region 1802 and a region 1803. In various embodiments, the regions 1801, 1802, and 1803 are rectangular regions or shaded regions in FIG. 9, FIG. 10, or FIG. 11.

Manner 5: (Example 16)

aligned(8) class qualitybox {

ROiregionstruct;

unsigned int(1) quality_ranking_ROI

unsigned int(8) region_dif;

unsigned int(1) quality_ranking_dif;

}

In this non-limiting example of a manner, a quantity of regions is be included, and only a region distance region_dif and a quality change between regions, namely, quality_ranking_dif, are described. If a value of quality_ranking_dif is 0, it indicates that quality remains unchanged between the regions, in some embodiments.

In some embodiments, if the value of quality_ranking_dif is less than 0, it indicates that the picture quality corresponding to the regions becomes lower; or if the value of quality_ranking_dif is greater than 0, it indicates that the picture quality corresponding to the regions becomes higher. Alternatively, in some embodiments, if the value of quality_ranking_dif is greater than 0, it indicates that the picture quality corresponding to the regions becomes lower; or if the value of quality_ranking_dif is less than 0, it indicates that the picture quality corresponding to the regions becomes higher.

In some embodiments, the value of quality_ranking_dif specifically represents a quality change amplitude.

It should be understood that, in various embodiments, the quality difference and the quality are quality ranks, or specific quality, for example, a PSNR or a MOS.

In this embodiment of the present application, ROiregionstruct describes region information of a region 1801. In various embodiments, the information is specific region information such as a region described in an existing standard, or a track ID of a timed metadata track of the ROI. In various embodiments, the information describes a location of the ROI in Manner 1, Manner 2, or Manner 3.

Manner 6

In various embodiments, quality_type in Manner 3 is of an ROI whose quality is described in a case of a 2D coordinate system, an ROI whose quality is described in a case of a spherical coordinate system, or an ROI in an extension region.

Manner 7: In various embodiments, in Manner 4 and Manner 5, region_dif is replaced with region_dif_h or region_dif_v, where region_dif_h represents a width difference between the region 1802 and the region 1801, and region_dif_v represents a height difference between the region 1802 and the region 1801.

In any one of Manner 1 to Manner 7, in some embodiments, qualitybox further includes other information such as a wide and/or height type identifier.

FIG. 13 is a schematic flowchart of a method ofr presenting video information according to an embodiment of the present application. In various embodiments, the method of presenting video information provided in this embodiment of the present application is applied to the DASH field or to another streaming media field, for example, RTP protocol-based streaming media transmission. In various embodiments, the method is performed by a client, a terminal, user equipment, a computer device, or a network device such as a gateway or a proxy server. As shown in the embodiment of FIG. 13, the method includes the following steps.

S1401. Obtain video content data and auxiliary data, wherein the video content data is configured to reconstruct a video picture, the video picture includes at least two picture regions, and the auxiliary data includes quality information of the at least two picture regions.

The at least two picture regions include a first picture region and a second picture region, the first picture region does not overlap the second picture region, and the first picture region and the second picture region have different picture quality. The quality information includes quality ranks of the picture regions, and the quality ranks are used to distinguish between relative picture quality of the at least two picture regions. The first picture region includes a high-quality picture region, a low-quality picture region, a background picture region, or a preset picture region.

In some embodiments, it should be understood that the obtained video content data is a to-be-decoded video bitstream, and is used to generate the video picture through decoding, and auxiliary data carries information used to indicate how to present the video picture generated through decoding.

In some embodiments, the video picture includes the first picture region, and a region other than the first picture region is referred to as the second picture region. The first picture region may be only one picture region, or may be a plurality of picture regions with a same property that are not connected to each other. In sme embodiments, in addition to the first picture region and the second picture region that do not overlap each other, the video picture includes a third picture region that overlaps neither the first picture region nor the second picture region.

In some embodiments, the first picture region and the second picture region have different picture quality. The picture quality includes one or both of subjective picture quality or objective picture quality. In various embodiments, the subjective picture quality is represented by a score ((for example, a mean opinion score, MOS) on a picture that is given by a viewer, and/or the objective picture quality is represented by a peak signal-to-noise ratio (PSNR) of a picture signal.

In some embodiments, the picture quality is represented by the quality information carried in the auxiliary data. When the video picture includes the at least two picture regions, the quality information is used to indicate picture quality of different picture regions in the same video picture. In some embodiments, the quality information exists in a form of a quality rank, e.g., a nonnegative integer or an integer in another form. In some embodiments, there is a relationship between different quality ranks: Higher quality of a video picture corresponds to a lower quality rank, or lower quality of a video picture corresponds to a higher quality rank. The quality rank represents relative picture quality of different picture regions.

In some embodiments, the quality information is respective absolute picture quality of the first picture region and the second picture region. For example, the MOS or a value of the PSNR is linearly or non-linearly mapped to a value range. For example, when the MOS is 25, 50, 75, and 100, corresponding quality information is respectively 1, 2, 3, and 4, or when an interval of the PSNR is [25, 30), [30, 35), [35, 40), and [40, 60) (dB), corresponding quality information is respectively 1, 2, 3, and 4. In some embodiments, the quality information is a combination of absolute quality of the first picture region and a quality difference between the first picture region and the second picture region. For example, the quality information includes a first quality indicator and a second quality indicator. When the first quality indicator is 2 and the second quality indicator is −1, it indicates that a picture quality rank of the first picture region is 2, and a picture quality rank of the second picture region is one quality rank lower than that of the first picture region.

Beneficial effects of the foregoing embodiments are as follows: Different picture regions of the video picture are presented at different quality ranks. A region of interest that is selected by most users for viewing or a region specified by a video producer is able to be presented by using a high-quality picture, and another region is presented by using a relatively low-quality picture, thereby reducing a data volume of the video picture.

In various embodiments, the first picture region is a picture region whose picture quality is higher than that of another region, a picture region whose picture quality is lower than that of another region, a foreground picture region, a background picture region, a picture region corresponding to a field of view of an author, a specified picture region, a preset picture region, a picture region of interest, or the like. This is not limited.

A beneficial effect of the foregoing embodiments is as follows: A high-quality region is able to be specified in different manners, so that an individual requirement of a viewer is met, and subjective video experience is improved.

S1402. Determine a presentation manner of the video content data based on the auxiliary data.

In some embodiments, the auxiliary data further includes location information and size information of the first picture region in the video picture. In some embodiments, it is determined to present, at a quality rank of the first picture region, a picture that is in the first picture region and that is determined by using the location information and the size information.

Specifically, in some embodiments, a range of the first picture region in the entire frame of video picture is determined based on the location information and the size information that are carried in the auxiliary data, and it is determined to present a picture in the range by using the quality rank that corresponds to the first picture region and that is carried in the auxiliary data.

The location information and the size information are the spatial information mentioned above. For a representation method and an obtaining manner of the location information and the size information, refer to the foregoing description. Details are not described again.

In some embodiments, the auxiliary data further includes a description manner of the location information and the size information of the first picture region in the video picture. Before the determining to present, at a quality rank of the first picture region, a picture that is in the first picture region and that is determined by using the location information and the size information, the method further includes: determining the location information and the size information from the auxiliary data based on the description manner. In some embodiments, the description manner is a first-type description manner in which the auxiliary data carries the location information and the size information of the first picture region. In some embodiments, the description manner is a second-type description manner in which the auxiliary data carries an identity of a region representation of the first picture region. In some embodiments, a representation independent of the representation of the first image region is retrieved by using the identity of the region representation, and the retrieved representation carries the location information and the size information of the first picture region. In some embodiments, the first picture region is a fixed region in the video picture, namely, a region whose location and size in each frame of picture remain unchanged in a specific time, where the region is referred to as a static region in some embodiments. As a static region, the first picture region is described in the first-type description manner in some embodiments. In some embodiments, the first picture region is a changing region in the video picture, namely, a region whose location or size in a different frame of picture changes in a specific time, where the region is referred to as a dynamic region in some embodiments. As a dynamic region, the first picture region is described in the second-type description manner in some embodiments.

Information about the description manner that is carried in the auxiliary data and that is of the location information and the size information of the first picture region in the video picture represents a location at which the location information and the size information are obtained from the auxiliary data.

Specifically, in some embodiments, the information about the description manner is represented by 0 or 1. The value 0 is used to represent the first-type description manner, that is, the location information and the size information of the first picture region in the video picture are obtained from first location description information in the auxiliary data. The value 1 is used to represent the second-type description manner, that is, the identity of the region representation of the first picture region in the video picture is obtained from second location description information in the auxiliary data, so as to further determine the location information and the size information, and the location information and the size information is able to be determined by parsing another independent representation. For example, when the information about the description manner is 0, a horizontal coordinate value and a vertical coordinate value of an upper-left location point, of the first picture region, in the video picture, a width of the first picture region, and a height of the first picture region are obtained from the auxiliary data. For a setting manner of a coordinate system in which the horizontal coordinate value and the vertical coordinate value are located, refer to the foregoing description of obtaining the spatial information. Details are not described again. When the information about the description manner is 1, the identity of the region representation of the first picture region in the video picture is obtained from the auxiliary data, and a region described by the region representation is the first picture region.

A beneficial effect of the foregoing embodiments is as follows: Different representation manners are provided for picture regions of different quality. For example, location information and region sizes of all picture regions whose quality remains high in each picture frame are statically set, and when a high-quality picture region in each picture frame changes with the frame, a location and a size of the high-quality picture region are dynamically represented frame by frame, thereby improving video presentation flexibility.

In a feasible implementation, the second picture region is a picture region other than the first picture region in the video picture. In some embodiments, it is determined to present the second picture region at a quality rank of the second picture region.

Specifically, when the range of the first picture region is determined, a range of the second picture region is also determined because there is a complementary relationship between the first picture region and the second picture region, and it is determined to present a picture in the range by using the quality rank that corresponds to the second picture region and that is carried in the auxiliary data.

In some embodiments, the auxiliary data further includes a first identifier used to indicate that a region edge of the first picture region is in a smooth state. When the first identifier indicates that the region edge of the first picture region is not smooth, it is determined to smooth the region edge of the first picture region.

When quality ranks of different picture regions adjacent to each other are different, at an edge between the picture regions, there may be visual perception that a picture has a demarcation line, or there may be a quality jump. When there is no such visual perception, the edge between the picture regions is smooth.

In some embodiments, the auxiliary data carries information used to indicate whether the edge of the first picture region is smooth.

Specifically, in some embodiments, the information is represented by 0 or 1. The value 0 indicates that the edge of the first picture region is not smooth, and this means that if a video picture subjective feeling needs to be enhanced, another picture processing operation, for example, various picture enhancement methods such as grayscale transformation, histogram equalization, low-pass filtering, or high-pass filtering, needs to be performed after video content information is decoded. The value 1 indicates that the edge of the first picture region is smooth, and this means that a better video picture subjective feeling may be achieved without performing another picture processing operation.

In some embodiments, the auxiliary data further includes a second identifier of a smoothing method used for the smoothing. When the first identifier indicates that the region edge of the first picture region is to be smoothed, it is determined to smooth the region edge of the first picture region by using the smoothing method corresponding to the second identifier.

Specifically, in various embodiments, the second identifier is a nonnegative integer, or an integer in another form. In some embodiments, the second identifier is represented as a specific picture processing method. For example, 0 represents the high-pass filtering, 1 represents the low-pass filtering, and 2 represents the grayscale transformation, so as to directly indicate a picture processing method for smoothing an edge of a picture region. In some embodiments, the second identifier is represented as a reason why an edge is not smooth. For example, 1 indicates that a high-quality region and a low-quality region are generated through encoding, 2 indicates that a low-quality region is generated through uniform or non-uniform spatial downsampling, 3 indicates that a low-quality region is generated through preprocessing filtering, 4 indicates that a low-quality region is generated through preprocessing spatial filtering, 5 indicates that a low-quality region is generated through preprocessing time domain filtering, and 6 indicates that a low-quality region is generated through preprocessing spatial filtering and preprocessing time domain filtering, so as to provide a basis for selecting a picture processing method for smoothing a picture edge.

In various embodiments, specific picture processing methods include the grayscale transformation, the histogram equalization, the low-pass filtering, the high-pass filtering, pixel resampling, and the like. For example, in some embodiments, reference is made to description of various picture processing methods in “Research on Image Enhancement Algorithms” published by the Wuhan University of Science and Technology on issue 04, 2008, which is incorporated by reference in its entirety in this embodiment of the present application. Details are not described.

Beneficial effects of the foregoing embodiments are as follows: When there are picture regions of different quality in a field of view of a user, the user may choose to smooth a picture edge, to improve visual experience of the user, or may choose not to smooth a picture edge, to reduce picture processing complexity. In particular, when the user is notified that the edge of the picture region is in the smooth state, better visual experience can be achieved even if picture processing is not performed, thereby reducing processing complexity of a device that performs processing and presents video content on a user side, and reducing power consumption of the device.

S1403. Present the video picture in the presentation manner of the video content data.

The video picture is presented in the presentation manner that is of the video content data and that is determined in step S1402 by using various types of information carried in the auxiliary data.

In some embodiments, step S1403 and step S1402 are performed together.

This embodiment of the present application may be applied to a DASH system. An MPD of the DASH system carries the auxiliary data. In some embodiments, the method includes: obtaining, by a client of the DASH system, a media representation and the MPD corresponding to the media representation that are sent by a server of the DASH system; parsing, by the client, the MPD to obtain the quality information of the at least two picture regions; and processing and presenting, by the client based on the quality information, a corresponding video picture represented by the media representation.

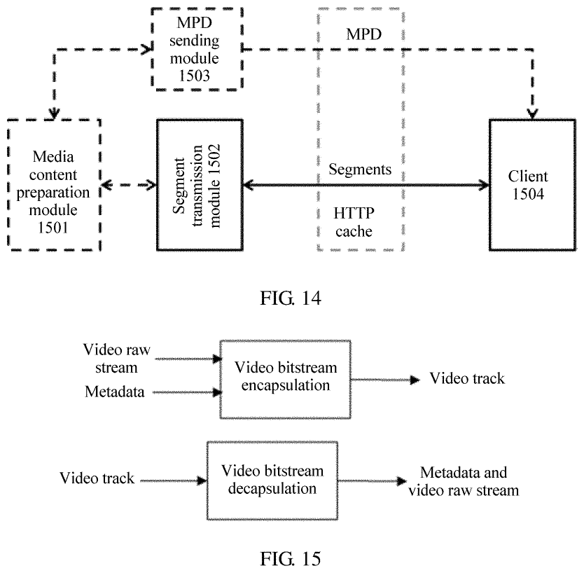

FIG. 14 is a schematic structural diagram of an end-to-end DASH system according to an embodiment of the present application. The end-to-end system includes four modules: a media content preparation module 1501, a segment transmission module 1502, an MPD sending module 1503, and a client 1504.

The media content preparation module 1501 generates video content that includes an MPD and that is provided for the client 1504. The segment transmission module 1502 is located in a website server, and provides the video content for the client 1504 according to a segment request of the client 1504. The MPD sending module 1503 is configured to send the MPD to the client 1504, and the module is also able to be located in the website server. The client 1504 receives the MPD and the video content, obtains auxiliary data such as quality information of different picture regions by parsing the MPD, and subsequently processes and presents the decoded video content based on the quality information.

In some embodiments, the quality information carried in the MPD is described by using an attribute @ scheme in SupplementalProperty.

An essential property descriptor (EssentialProperty) or supplemental property descriptor (SupplementalProperty) of the MPD is used as an example:

Syntax Table:

| EssentialProperty @ | | |
|---|---|---|
| value or | | |
| SupplementalProperty @ | | |
| value parameter | Use | Description |
| quality_rank | M | The parameter describes a quality |
| (quality rank) | (Man- | rank of a target region, and is an |
| | datory) | integer. In a same MPD, a larger |
| | | value of the parameter indicates |
| | | lower quality of the target region. |
| smoothEdge | M | The parameter describes whether |
| (smooth edge) | | there is a smooth transition |
| | | between quality of adjacent |
| | | regions with different quality |
| | | ranks. If there is a smooth |
| | | transition between the quality, |
| | | a value of the parameter is 1. |
| | | Otherwise, a value is 0. |
| region_x | M | The parameter describes a |
| (horizontal | | horizontal coordinate of an |
| coordinate | | upper-left location point, of the |
| of a region) | | target region, in a picture. |
| region_y | M | The parameter describes a |
| (vertical | | vertical coordinate of the |
| coordinate | | upper-left location point, |
| of a region) | | of the target region, in |
| | | the picture. |
| region_w | M | The parameter describes a |
| (width of a | | width of the target region. |
| region) | | |
| region_h | M | The parameter describes a |
| (height of a | | height of the target region. |
| region) | | |
| others_rank | M | The parameter describes a |
| (quality rank of | | quality rank of a region other |
| another region) | | than the target region. |

Specific MPD Example: (Example 17)

<MPD
<AdaptationSet [...]>
<Representation id=“9” bandwidth=“50000” width=“1920”

height=“1080”>

<EssentialProperty schemeIdUri=“urn:mpeg:dash:rgqr:2017” value=“0,

1,180,45,1280,720,2”>

<BaseURL>tile9.mp4</BaseURL>
</Representation>
<Representation id=“10” bandwidth=“5000” width=“1280” height=“720”>
<BaseURL>tile10.mp4</BaseURL>
</Representation>
</AdaptationSet>
...
</MPD>

In the MPD example, it indicates that in video content in a case of Representation id=“9”, there is one spatial region description scheme whose schemeldUri is “urn:mpeg:dash:rgqr:2017”, and a value of the field is “0, 1, 180, 45, 1280, 720, 2”, which semantically means that in the case of Representation id=“9”, in a corresponding video picture, the target region has an upper-left location point with coordinates of (180, 45), is a picture region with a region range of 1280×720, and has a quality rank of 0, a quality rank of another region in the video picture is 2, and an edge between adjacent regions is smooth.

After obtaining the MPD, the client performs the following operation:

S1601. Obtain video content data and auxiliary data, where the video content data is used to reconstruct a video picture, the video picture includes at least two picture regions, and the auxiliary data includes quality information of the at least two picture regions.

Specifically, the client parses the EssentialProperty or SupplementalProperty element in the MPD, and learns of, based on a scheme of the element, the quality information of the at least two picture regions that is represented by the scheme.

Different picture regions of a video picture are presented at different quality ranks. In some embodiments, a region of interest that is selected by most users for viewing or a region specified by a video producer is presented by using a high-quality picture, and another region is presented by using a relatively low-quality picture, thereby reducing a data volume of the video picture.

S1602. Determine a presentation manner of the video content data based on the auxiliary data.

Specifically, the field schemeIdUri=“urn:mpeg:dash:rgqr:2017” is parsed, to obtain values of parameters such as quality_rank, smoothEdge, region_x, region_y, region_w, region_h, and others_rank, so that it is determined that the quality rank of the target region is 0, the edge between adjacent regions is smooth, and the quality rank of the picture region other than the target region in the video picture corresponding to the representation is 2, and the horizontal coordinate of the upper-left location of the target region, the vertical coordinate of the upper-left location of the target region, the width of the target region, the height of the target region are determined.

S1603. Present the video picture in the presentation manner of the video content data.

Specifically, the client determines the presentation manner of the video data based on location information, size information, quality ranks of different picture regions, and information about whether an edge between adjacent picture regions is smooth that are determined in step S1602.

In some embodiments, the client selects, based on a field of view of a user, a representation of a specified region with a quality rank indicating high quality.

In some embodiments, if content presented in a current field of view region includes some regions with a high quality rank and some regions with a low quality rank due to a change of the field of view of the user, the client directly presents the video content in a case of smoothEdge=1, or the client needs to perform video quality smoothing processing such as Wiener filtering or Kalman filtering on the video content in a case of smoothEdge=0.

When there are picture regions of different quality in the field of view of the user, the user may choose to smooth a picture edge, to improve visual experience of the user, or may choose not to smooth a picture edge, to reduce picture processing complexity. In particular, when the user is notified that the edge of the picture region is in a smooth state, better visual experience can be achieved even if picture processing is not performed, thereby reducing processing complexity of a device that performs processing and presents video content on a user side, and reducing power consumption of the device.

In some embodiments, the information carried in the MPD further includes information about a description manner of the location information and the size information of the target picture region in the video picture.

Syntax Table:

| EssentialProperty @ | | |
|---|---|---|
| value or | | |
| SupplementalProperty @ | | |
| value parameter | Use | Description |
| regiontype | M | The parameter describes a type of |
| (region type) | (Man- | the target region. A value 0 indicates |
| | datory) | that a current representation carries |
| | | the location information and the size |
| | | information of the target region. A |
| | | value 1 indicates that a current |
| | | representation carries an identity |
| | | (ID) of a region representation |
| | | corresponding to the target region, a |
| | | representation independent of the |
| | | current representation may be |
| | | retrieved by using the identity of the |
| | | region representation, and the |
| | | location information and the size |
| | | information of the target region may |
| | | be obtained by parsing the |
| | | representation. |
| quality_rank | M | The parameter describes a quality |
| (quality rank) | | rank of the target region, and is an |
| | | integer. In a same MPD, a larger |
| | | value of the parameter indicates |
| | | lower quality of the target region. |
| smoothEdge | M | The parameter describes whether |
| (smooth edge) | | there is a smooth transition between |
| | | quality of adjacent regions with |
| | | different quality ranks. If there is a |
| | | smooth transition between the |
| | | quality, a value of the parameter is |
| | | 1. Otherwise, a value is 0. |
| region_x | O | The parameter describes a |
| (horizontal | (op- | horizontal coordinate of an |
| coordinate | tional) | upper-left location point, of the |
| of a region) | | target region, in a picture. This |
| | | parameter exists when the value of |
| | | regiontype is 0. Otherwise, this |
| | | parameter does not exist. |
| region_y | O | The parameter describes a vertical |
| (vertical | | coordinate of an upper-left location |
| coordinate | | point, of the target region, in the |
| of a region) | | picture. This parameter exists when |
| | | the value of regiontype is 0. |
| | | Otherwise, this parameter does not |
| | | exist. |
| region_w | O | The parameter describes a width of |
| (width of a | | the target region. This parameter |
| region) | | exists when the value of regiontype |
| | | is 0. Otherwise, this parameter does |
| | | not exist. |
| region_h | O | The parameter describes a height of |
| (height of a | | the target region. This parameter |
| region) | | exists when the value of regiontype |
| | | is 0. Otherwise, this parameter does |
| | | not exist. |
| region_repre- | O | The parameter describes the identity |
| sentation_id | | of the representation of the target |
| (identity of a region | | region. This parameter exists when |
| representation) | | the value of regiontype is 1. |
| | | Otherwise, this parameter does not |
| | | exist. |
| others_rank | M | The parameter describes a quality |
| (quality rank of | | rank of a region other than the target |
| another region) | | region. |

Specific MPD Example: (Example 18):

<MPD
<AdaptationSet [...]>
<Representation id=“9” bandwidth=“50000” width=“1920”

height=“1080”>

<EssentialProperty schemeIdUri=“urn:mpeg:dash:rgqr:2017” value=“0,0,

1,180,45,1280,720,2”>

<BaseURL>tile9.mp4</BaseURL>
</Representation>

<Representation id=“10” bandwidth=“5000” width=“1280”

height=“720”>

<BaseURL>tile10.mp4</BaseURL>
</Representation>
</AdaptationSet>
...
</MPD>

In Example 18 of the MPD, it indicates that in video content in a case of Representation id=“9”, there is one spatial region description scheme whose schemeIdUri is “urn:mpeg:dash:rgqr:2017”, and a value of the field is “0, 0, 1, 180, 45, 1280, 720, 2”, which semantically means that in the case of Representation id=“9”, in a corresponding video picture, the target picture region has an upper-left location point with coordinates of (180, 45), has a region range of 1280×720, and has a quality rank of 0, a quality rank of another region in the video picture is 2, and an edge between adjacent regions is smooth.

Specific MPD Example: (Example 19):

<MPD
<AdaptationSet [...]>
<Representation id=“9” bandwidth=“50000” width=“1920”

height=“1080”>

<EssentialProperty schemeIdUri=“urn:mpeg:dash:rgqr:2017” value=“1,0,

1,region,2”/>

<BaseURL>tile9.mp4</BaseURL>
</Representation>

<Representation id=“10” bandwidth=“5000” width=“1280”

height=“720”>

<BaseURL>tile10.mp4</BaseURL>
</Representation>
</AdaptationSet>

<AdaptationSet segmentAlignment=“true” subsegmentAlignment=“true”

subsegmentStartsWithSAP=“1”>

<Representation id=“region” associationId=“9” associationType=“cdsc”

codecs=“2dcc” bandwidth=“100”>

<BaseURL>roi_coordinates.mp4</BaseURL>
</Representation>
</AdaptationSet>
...
</MPD>

In Example 19 of the MPD, it indicates that in video content in a case of Representation id=“9”, there is one spatial region description scheme whose schemeIdUri is “urn:mpeg:dash:rgqr:2017”, and a value of the field is “1, 0, 1, region, 2”, which semantically means that in the case of Representation id=“9”, in a corresponding video picture, an ID of a region representation of the target picture region in the video picture is region, a quality rank of the target picture region is 0, a quality rank of another region in the video picture is 2, and an edge between adjacent regions is smooth.

In some embodiments, the client further obtains, by parsing the MPD, URL construction information of a bitstream described by the region representation whose ID is region, construct a URL of the region representation by using the URL construction information, request bitstream data of the region representation from the server, and after obtaining the bitstream data, parse the bitstream data to obtain the location information and the size information of the target picture region.

In some embodiments, regiontype=0 indicates a fixed region in the video picture, namely, a region whose location and size in each frame of picture remain unchanged in a specific time, where the region is also referred to as a static region; and regiontype=1 indicates a changing region in the video picture, namely, a region whose location or size in a different frame of picture changes in a specific time, where the region is also referred to as a dynamic region.

Correspondingly, in some embodiments, in step S1602, specifically, the value of regiontype is first obtained by parsing the field schemeIdUri=“urn:mpeg:dash:rgqr:2017”, to determine, based on the value of regiontype, whether the location information and the size information of the target region come from region_x, region_y, region_w, and region_h (when regiontype indicates a static picture) or come from region_representation_id (when regiontype indicates a dynamic picture), and then the presentation manner of the picture region is determined based on another parameter obtained by parsing the field. Details are not described again.

It should be understood that there are a plurality of representation manners of the location information and the size information of the target region. For details, refer to the foregoing description of obtaining the spatial information. Details are not described again.

It should be understood that regiontype is used as an example to indicate a manner of obtaining spatial information in the MPD, in other words, indicate a field to be parsed to obtain the spatial information, and the manner is unrelated to a specific manner of representing the location information and the size information of the target region.

In some embodiments, different representation manners are provided for picture regions of different quality. For example, location information and region sizes of all picture regions whose quality remains high in each picture frame are statically set, and when a high-quality picture region in each picture frame changes with the frame, a location and a size of the high-quality picture region are dynamically represented frame by frame, thereby improving video presentation flexibility.

In some embodiments, a manner of obtaining spatial information in the MPD is represented in another form. An example is as follows:

Specific MPD Example: (Example 20):

<MPD
<AdaptationSet [...]>
<Representation id=“9” bandwidth=“50000” width=“1920”

height=“1080”>

<EssentialProperty schemeIdUri=“urn:mpeg:dash:rgqr_dynamic:2017”

value=“l,0, 1,region,2”/>

<BaseURL>tile9.mp4</BaseURL>
</Representation>

<Representation id=“10” bandwidth=“5000” width=“1280”

height=“720”>

<BaseURL>tile10.mp4</BaseURL>
</Representation>
</AdaptationSet>

<AdaptationSet segmentAlignment=“true” subsegmentAlignment=“true”

subsegmentStartsWithSAP=“1”>

<Representation id=“region” associationId=“9” associationType=“cdsc”

codecs=“2dcc” bandwidth=“100”>

<BaseURL>roi_coordinates.mp4</BaseURL>
</Representation>
</AdaptationSet>
...
</MPD>

In Example 20 of the MPD, the field schemeIdUri=“urn:mpeg:dash:rgqr_dynamic:2017” is used to indicate that the location information and the size information of the target region are obtained by parsing a region representation whose ID is region and that is independent of a current representation, and information about the identity (id) of the representation is able to be subsequently semantically obtained through parsing, which is suitable for a dynamic region scenario. Correspondingly, the field schemeIdUri=“urn:mpeg:dash:rgqr:2017” is able to be used to indicate that the location information and the size information of the target region are carried in a current representation, which is suitable for a static region scenario.

In some embodiments, the information carried in the MPD further includes an identifier of a smoothing method used for an edge between adjacent regions.

Syntax Table:

| EssentialProperty @ | | |
|---|---|---|
| value or | | |
| SupplementalProperty @ | | |
| value parameter | Use | Description |
| quality_rank | M | The parameter describes a quality |
| (quality rank) | (Man- | rank of the target region, and is an |
| | datory) | integer. In a same MPD, a larger |
| | | value of the parameter indicates |
| | | lower quality of the target region. |
| smoothEdge | M | The parameter describes whether |
| (smooth edge) | | there is a smooth transition between |
| | | quality of adjacent regions with |
| | | different quality ranks. If there is a |
| | | smooth transition between the |
| | | quality, a value of the parameter is |
| | | 1. Otherwise, a value is 0. |
| region_x | M | The parameter describes a |
| (horizontal | | horizontal coordinate of an |
| coordinate | | upper-left location point, of the |
| of a region) | | target region, in a picture. |
| region_y | M | The parameter describes a vertical |
| (vertical | | coordinate of the upper-left location |
| coordinate | | point, of the target region, in the |
| of a region) | | picture. |
| region_w | M | The parameter describes a width of |
| (width of a | | the target region. |
| region) | | |
| region_h | M | The parameter describes a height of |
| (height of a | | the target region. |
| region) | | |
| others_rank | M | The parameter describes a quality |
| (quality rank of | | rank of a region other than the target |
| another region) | | region. |
| Smooth_method | M | The parameter describes a |
| (smoothing method) | | smoothing method. |

Specific MPD Example: (Example 21):

<MPD
<AdaptationSet [...]>
<Representation id=“9” bandwidth=“50000” width=“1920”

height=“1080”>

<EssentialProperty schemeIdUri=“urn:mpeg:dash:rgqr:2017” value=“0,

1,180,45,1280,720,2,1”>

<BaseURL>tile9.mp4</BaseURL>
</Representation>

<Representation id=“10” bandwidth=“5000” width=“1280”

height=“720”>

<BaseURL>tile10.mp4</BaseURL>
</Representation>
</AdaptationSet>
...
</MPD>

In the MPD example, it indicates that in video content in a case of Representation_id=“9”, there is one spatial region description scheme whose schemeIdUri is “urn:mpeg:dash:rgqr:2017”, and a value of the field is “0, 0, 180, 45, 1280, 720, 2, 1”, which semantically means that in the case of Representation_id=“9”, in a corresponding video picture, the target region has an upper-left location point with coordinates of (180, 45), is a picture region with a region range of 1280×720, and has a quality rank of 0, a quality rank of another region in the video picture is 2, an edge between adjacent regions is not smooth, and when the edge between adjacent regions is not smooth, the edge is smoothed by using a smoothing method with a number of 1.

Correspondingly, in some embodiments, in step S1602, a smoothing method is further determined by obtaining Smooth_method, and in step S1603, the determining a presentation manner of the video data includes: presenting, when the video data is to be presented, video data smoothed by using the smoothing method.

A specific smoothing method is notified, to help the client select an appropriate method for smoothing, thereby improving subjective video experience of the user.

It should be understood that, in various embodiments, a value of Smooth_method corresponds to a specific smoothing method such as Wiener filtering, Kalman filtering, or upsampling, or to information indicating how to select a smoothing method, for example, a reason why an edge is not smooth, for example, a high-quality region and a low-quality region are generated through encoding, or a low-quality region is generated through uniform or non-uniform spatial downsampling.

It should be understood that, in various embodiments, Smooth_method and smoothEdge are associated with each other, in other words, only when smoothEdge indicates that an edge is not smooth, Smooth_method exists, or exist independently from each other. This is not limited.

This embodiment of the present application may be applied to a video track transmission system. In some embodiments, a raw stream of the transmission system carries the video content data, and the raw stream and the auxiliary data are encapsulated in a video track in the transmission system. In some embodiments, the method includes: obtaining, by a receive end of the transmission system, the video track sent by a generator of the transmission system; parsing, by the receive end, the auxiliary data to obtain the quality information of the at least two picture regions; and processing and presenting, by the receive end based on the quality information, a video picture obtained by decoding the raw stream in the video track.

FIG. 15 is a schematic structural diagram of a video track transmission system according to an embodiment of the present application. The system includes a video track generation side and a video track parsing side. On the video track generation side, a video encapsulation module obtains video raw stream data and metadata (namely, auxiliary data), and encapsulates the metadata and the video raw stream data in a video track. The video raw stream data is encoded according to a video compression standard (for example, the standard H.264 or H.265). The video raw stream data obtained by the video encapsulation module is divided into a video network abstraction layer unit (NALU), and the metadata includes quality information of a target region. On the video track parsing side, a video decapsulation module obtains and parses data of the video track to obtain the video metadata and the video raw stream data, and processes and presents video content based on the video metadata and the video raw stream data.

In some embodiments, quality information of different regions is described in the metadata in the track by using an ISO/IEC BMFF format.

Example (Example 22) of describing quality information of different regions in qualitybox:

aligned(8) class qualitybox{
unsigned int(16) top_left_x;//horizontal coordinate of an upper-left point

of the target region

unsigned int(16) top_left_y;//vertical coordinate of the upper-left point of

the target region

unsigned int(16) reference_width;//width of the target region
unsigned int(16) reference_height;//height of the target region
unsigned int(8) smoothEdge;//whether an edge between adjacent picture

regions is smooth

unsigned int(8) quality_rank;//quality rank of the target region
unsigned int(8) other_rank;//quality rank of a region other than the target

region

...
}; or
(Example 23):
aligned(8) class qualitybox{
unsigned int(16) num_regions;//quantity of regions
unsigned int(16) remaining_area_flag;//0 indicates a region whose location

and size need to be described, and 1 indicates a remaining region whose location and
size are not described

for (i=0; i<num_regions; i++) {
if (remaining_area_flag=0)
{
location and size of a region
}
unsigned int(8) smoothEdge;//whether an edge between adjacent picture

regions is smooth

unsigned int(8) quality_rank;//quality rank, which describes, in a case of

remaining_area_flag=1, a quality rank of the remaining region whose location and
size are not described, or which describes, in a case of remaining_area_flag=0, a
quality rank of the region whose location and size need to be described

}
}; or
(Example 24):
aligned(8) class qualitybox{
unsigned int(16) num_regions;//quantity of regions
unsigned int(16) remaining_area_flag;//0 indicates a region whose location

and size need to be described, and 1 indicates a remaining region whose location and
size are not described

for (i=0; i<num_regions; i++) {
if (remaining_area_flag=0)
{
location and size of a region
}
unsigned int(8) quality_rank;//quality rank, which describes, in a case of

remaining_area_flag=1, a quality rank of the remaining region whose location and
size are not described, or which describes, in a case of remaining_area_flag=0, a
quality rank of the region whose location and size need to be described

}
unsigned int(8) smoothEdge;//whether an edge between adjacent picture

regions is smooth

}

This implementation corresponds to the first feasible implementation, and reference may be made to the execution manner of the client in the first feasible implementation. Details are not described again.

In a fifth feasible implementation, there is an example (Example 25) of describing quality information of different regions in qualitybox:

aligned(8) class qualitybox{
unsigned int(8) regionType;//manner of obtaining location information and

size information of the target region

if (regionType=0) {//Static picture
unsigned int(16) top_left_x;//horizontal coordinate of an upper-left point

of the target region

unsigned int(16) top_left_y;//vertical coordinate of the upper-left point of

the target region

unsigned int(16) reference_width;//width of the target region
unsigned int(16) reference_height;//height of the target region
}
if (regionType=1) {//dynamic picture
unsigned int(8) region_representation_id;//identity of a region

representation

}
unsigned int(8) smoothEdge;//whether an edge between adjacent picture

regions is smooth

unsigned int(8) quality_rank;//quality rank of the target region
unsigned int(8) other_rank;//quality rank of a region other than the target

region

...
}

This implementation corresponds to the second feasible implementation, and reference may be made to the execution manner of the client in the second feasible implementation. Details are not described again.

In a sixth feasible implementation, there is an example (Example 26) of describing quality information of different regions in qualitybox:

aligned(8) class qualitybox{
unsigned int(16) top_left_x;//horizontal coordinate of an upper-left point

of the target region

unsigned int(16) top_left_y;//vertical coordinate of the upper-left point of

the target region

unsigned int(16) reference_width;//width of the target region
unsigned int(16) reference_height;//height of the target region
unsigned int(8) smoothEdge;//whether an edge between adjacent picture

regions is smooth

unsigned int(8) quality_rank;//quality rank of the target region
unsigned int(8) other_rank;//quality rank of a region other than the target

region

unsigned int(8) smoothMethod;//smoothing method
...
}; or
(Example 27):
aligned(8) class qualitybox{
unsigned int(16) num_regions;//quantity of regions
unsigned int(16) remaining_area_flag;//0 indicates a region whose location

and size need to be described, and 1 indicates a remaining region whose location and
size are not described

for (i=0; i<num_regions; i++) {
if (remaining_area_flag=0)
{
location and size of a region
}
unsigned int(8) quality_rank;//quality rank, which describes, in a case of

remaining_area_flag=1, a quality rank of the remaining region whose location and
size are not described, or which describes, in a case of remaining_area_flag=0, a
quality rank of the region whose location and size need to be described

}
unsigned int(8) smoothEdge;//whether an edge between adjacent picture

regions is smooth

unsigned int(8) smoothMethod;//smoothing method
}

This implementation corresponds to the execution manner of the client discussed above with respect to FIG. 14. Details are not described again.

It should be understood that, in various embodiments, the DASH system and the video track transmission system are independent of each other, or are compatible with each other. For example, the MPD information and the video content information need to be transmitted in the DASH system, and the video content information is a video track in which the video raw stream data and the metadata are encapsulated.

Therefore, the foregoing embodiments are able to be separately executed or combined with each other.

For example, in some embodiments, the MPD information received by the client carries the following auxiliary data:

<MPD
<AdaptationSet [...]>
<Representation id=“9” bandwidth=“50000” width=“1920”

height=“1080”>

<EssentialProperty schemeIdUri=“urn:mpeg:dash:rgqr:2017” value=“0,

1,180,45,1280,720,27>

<BaseURL>tile9.mp4</BaseURL>
</Representation>

<Representation id=“10” bandwidth=“5000” width=“1280”

height=“720”>

<BaseURL>tile10.mp4</BaseURL>
</Representation>
</AdaptationSet>
...
</MPD>

The client decapsulates the video track, and the obtained metadata carries the following auxiliary data:

aligned(8) class qualitybox{

...
unsigned int(8)smoothMethod;
...
}

Therefore, with reference to the auxiliary data obtained from the MPD information and the auxiliary data obtained from the metadata encapsulated in the video track, the client is able to obtain, based on the MPD information, the location information and the size information of the target region, the quality ranks of the target region and the region other than the target region, and the information about whether an edge between adjacent regions of different quality is smooth, and determine, based on the smoothing method information obtained from the metadata, the method for processing and presenting the video content data.

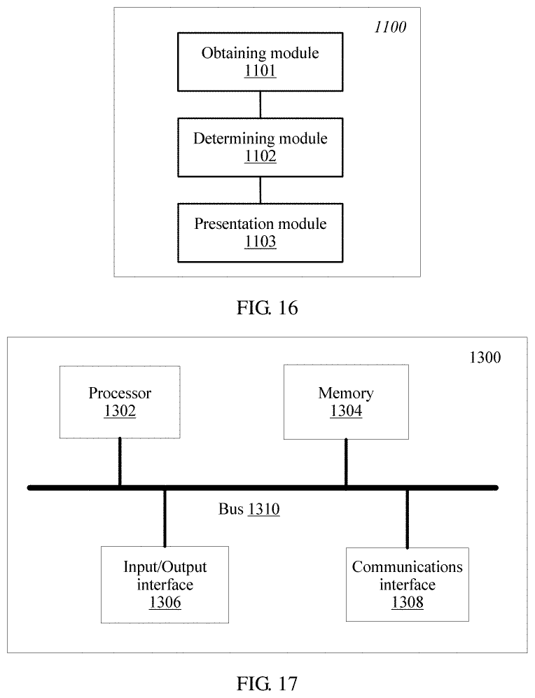

FIG. 16 shows an apparatus 1100 for presenting video information according to an embodiment of the present application. In some embodiments, the apparatus 1100 for presenting video information is a client, e.g., a computer device. The apparatus 1100 includes an obtaining module 1101, a determining module 1102, and a presentation module 1103.

The obtaining module is configured to obtain video content data and auxiliary data, wherein the video content data is used to reconstruct a video picture, the video picture includes at least two picture regions, and the auxiliary data includes quality information of the at least two picture regions.

The determining module is configured to determine a presentation manner of the video content data based on the auxiliary data.

The presentation module is configured to present the video picture in the presentation manner of the video content data.

In some embodiments, the at least two picture regions include a first picture region and a second picture region, the first picture region does not overlap the second picture region, and the first picture region and the second picture region have different picture quality.

In some embodiments, the quality information includes quality ranks of the picture regions, and the quality ranks are used to distinguish between relative picture quality of the at least two picture regions.

In some embodiments, the auxiliary data further includes location information and size information of the first picture region in the video picture; and correspondingly, the determining module is specifically configured to determine to present, at a quality rank of the first picture region, a picture that is in the first picture region and that is determined by using the location information and the size information.

In some embodiments, the second picture region is a picture region other than the first picture region in the video picture, and the determining module is specifically configured to determine to present the second picture region at a quality rank of the second picture region.

In some embodiments, the auxiliary data further includes a first identifier used to indicate that a region edge of the first picture region is in a smooth state; and correspondingly, when the first identifier indicates that the region edge of the first picture region is not smooth, the determining module is specifically configured to determine to smooth the region edge of the first picture region.

In some embodiments, the auxiliary data further includes a second identifier of a smoothing method used for the smoothing; and correspondingly, when the first identifier indicates that the region edge of the first picture region is to be smoothed, the determining module is specifically configured to determine to smooth the region edge of the first picture region by using the smoothing method corresponding to the second identifier.

In some embodiments, the smoothing method includes grayscale transformation, histogram equalization, low-pass filtering, or high-pass filtering.

In some embodiments, the auxiliary data further includes a description manner of the location information and the size information of the first picture region in the video picture; and correspondingly, before determining to present, at the quality rank of the first picture region, the picture that is in the first picture region and that is determined by using the location information and the size information, the determining module is further configured to determine the location information and the size information from the auxiliary data based on the description manner.

In some embodiments, the first picture region includes a high-quality picture region, a low-quality picture region, a background picture region, or a preset picture region.

It may be understood that, in various embodiments, functions of the obtaining module 1101, the determining module 1102, and the presentation module 1103 are implemented through software programming, hardware programming, or a circuit. This is not limited herein.

It may be understood that, in various embodiments, functions of each function module in the apparatus 1100 for presenting video information in this embodiment are specifically implemented according to the method in the foregoing method embodiment. For a specific implementation process thereof, refer to the related description in the foregoing method embodiment. Details are not described herein again.

FIG. 17 is a schematic diagram of a hardware structure of a computer device 1300 according to an embodiment of the present application. As shown in FIG. 17, the computer device 1300 is able to be used as an implementation of apparatus 1100 for presenting video information. The computer device 1300 includes a processor 1302, a memory 1304, an input/output interface 1306, a communications interface 1308, and a bus 1310. The processor 1302, the memory 1304, the input/output interface 1306, and the communications interface 1308 are communicatively connected to each other by using the bus 1310.

In various embodiments, the processor 1302 is a general purpose central processing unit (CPU), a microprocessor, an application-specific integrated circuit (ASIC), or one or more integrated circuits, and is configured to execute a related program, to implement the functions that need to be performed by the modules included in the apparatus 1100 for presenting video information, and/or to perform the streaming media information processing method that corresponds to FIG. 8 or FIG. 16 and that is provided in the method embodiment of the present application. In some embodiments, the processor 1302 is an integrated circuit chip, and has a signal processing capability. In an implementation process, steps in the foregoing method can be implemented by using an integrated logical circuit of hardware in the processor 1302, or by using an instruction in a form of software. In various embodiments, the processor 1302 is a general purpose processor, a digital signal processor (DSP), an application-specific integrated circuit (ASIC), a field programmable gate array (FPGA) or another programmable logic device, a discrete gate or a transistor logic device, or a discrete hardware component. The processor is able to implement or perform the methods, the steps, and logical block diagrams that are disclosed in the embodiments of the present application. In various embodiments, the general purpose processor is a microprocessor, any conventional processor, or the like. Steps of the methods disclosed with reference to the embodiments of the present application are able to be directly performed and accomplished by a hardware decoding processor, or are able to be performed and accomplished by using a combination of hardware and software modules in the decoding processor. In some embodiments, the software module is located in a mature storage medium in the art, such as a random access memory, a flash memory, a read-only memory, a programmable read-only memory, an electrically erasable programmable memory, or a register. The storage medium is located in the memory 1304. The processor 1302 reads information in the memory 1304, and completes, by using hardware of the processor 1302, the functions that need to be performed by the modules included in the apparatus 1100 for presenting video information, or performs the streaming media information processing method that corresponds to FIG. 8 or FIG. 16 and that is provided in the method embodiment of the present application.

In various embodiments, the memory 1304 is a read-only memory (ROM), a static storage device, a dynamic storage device, or a random access memory (RAM). The memory 1304 is able to store an operating system and another application program. When the functions that need to be performed by the modules included in the apparatus 1100 for presenting processing video information provided in the embodiments of the present application is implemented by using software or firmware, or the method for presenting video information that corresponds to FIG. 13 and that is provided in the method embodiment of the present application is performed, program code used to implement the technical solutions provided in the embodiments of the present application is stored in the memory 1304, and the processor 1302 performs the operations that need to be performed by the modules included in the apparatus 1100 for presenting video information.

The input/output interface 1306 is configured to: receive input data and information, and output data such as an operation result, and may be used as the obtaining module 1101 in the apparatus 1100.

The communications interface 1308 implements communication between the computer device 1300 and another device or a communications network by using a transceiver apparatus including but not limited to a transceiver, and may be used as the obtaining module 1101 in the apparatus 1100.

The bus 1310 includes a channel used to transfer information between components (such as the processor 1302, the memory 1304, the input/output interface 1306, and the communications interface 1308) of the computer device 1300.

It should be noted that although for the computer device 1300 shown in FIG. 17, merely the processor 1302, the memory 1304, the input/output interface 1306, the communications interface 1308, and the bus 1310 are shown, in a specific implementation process, a person skilled in the art should understand that the computer device 1300 further includes another device needed for normal running. For example, when being used as an implementation of the apparatus 1100 for processing video information, in some embodiments, the computer device 1300 further includes a display, configured to display to-be-played video data. In addition, based on a specific requirement, a person skilled in the art should understand that the computer device 1300 further includes hardware devices for implementing other additional functions in some embodiments. In addition, a person skilled in the art should understand that the computer device 1300 includes only devices needed for implementing this embodiment of the present application, but not necessarily include all the devices shown in FIG. 17, in some embodiments.

It should be noted that to make the description brief, the foregoing method embodiments are expressed as a series of actions. However, a person skilled in the art should appreciate that the present application is not limited to the described action sequence, because according to the present application, some steps are able to be performed in another sequence or performed simultaneously. In addition, a person skilled in the art should also appreciate that all the embodiments described in the specification are a part of embodiments, and the related actions and modules are not necessarily mandatory to the present application. A person of ordinary skill in the art may understand that all or some of the processes of the methods in the embodiments are able to be implemented by a computer program instructing related hardware. The program is able to be stored in a computer readable storage medium. When the program runs, the processes in the method embodiments are performed. In various embodiments, the storage medium includes a magnetic disk, an optical disc, a read-only memory, a random access memory, or the like.

Although the present application is described with reference to the embodiments, in a process of implementing the present application that claims protection, a person skilled in the art may understand and implement another variation of the disclosed embodiments by viewing the accompanying drawings, the disclosed content, and the accompanying claims. In the claims, “comprising” does not exclude another component or another step, and “a” or “one” does not exclude a case of a plurality of. A single processor or another unit may implement several functions enumerated in the claims. Some measures are recorded in dependent claims that are different from each other, but this does not mean that these measures cannot be combined to produce a better effect. A computer program may be stored/distributed in an appropriate medium such as an optical storage medium or a solid-state medium, and be provided together with other hardware or be used as a part of hardware, or may be distributed in another manner, for example, by using the Internet, or another wired or wireless telecommunications system.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method of presenting video information, the method comprising:
obtaining video content data and auxiliary data, wherein the video content data is configured to reconstruct a video picture, the video picture comprises at least two picture regions, and the auxiliary data comprises quality information of the at least two picture regions;
determining a presentation manner of the video content data based on the auxiliary data; and
presenting the video picture in the presentation manner of the video content data.

2. The method according to claim 1, wherein the at least two picture regions comprise a first picture region and a second picture region, the first picture region does not overlap the second picture region, and the first picture region and the second picture region have different picture quality indicated by the quality information.

3. The method according to claim 1, wherein the quality information comprises quality ranks of the picture regions, and the quality ranks correspond to relative picture quality of the at least two picture regions.

4. The method according to claim 2, wherein the auxiliary data further comprises location information and size information of the first picture region in the video picture; and
the determining the presentation manner of the video content data based on the auxiliary data comprises:
determining to present, at a quality rank of the first picture region, a picture that is in the first picture region and that is determined by using the location information and the size information.

5. The method according to claim 4, wherein the second picture region is a picture region other than the first picture region in the video picture, and the determining the presentation manner of the video content data based on the auxiliary data further comprises:
determining to present the second picture region at a quality rank of the second picture region.

6. The method according to claim 2, wherein the auxiliary data further comprises a first identifier that indicates whether or not a region edge of the first picture region is in a smooth state; and
the determining the presentation manner of the video content data based on the auxiliary data comprises:
when the first identifier indicates that the region edge of the first picture region is not in a smooth state, determining to smooth the region edge of the first picture region.

7. The method according to claim 6, wherein the auxiliary data further comprises a second identifier of a smoothing method used for the smoothing; and
the determining the presentation manner of the video content data based on the auxiliary data comprises:
when the first identifier indicates that the region edge of the first picture region is to be smoothed, determining to smooth the region edge of the first picture region by using the smoothing method corresponding to the second identifier.

8. The method according to claim 7, wherein the smoothing method comprises grayscale transformation, histogram equalization, low-pass filtering, or high-pass filtering.

9. The method according to claim 4, wherein the auxiliary data further comprises a description manner of the location information and the size information of the first picture region in the video picture; and
before the determining to present, at the quality rank of the first picture region, the picture that is in the first picture region and that is determined by using the location information and the size information, the method further comprises:
determining the location information and the size information from the auxiliary data based on the description manner.

10. The method according to claim 2, wherein the first picture region comprises a high-quality picture region, a low-quality picture region, a background picture region, or a preset picture region.

11. The method according to claim 1, wherein
the method is applied to a dynamic adaptive streaming over hypertext transfer protocol (DASH) system, a media representation of the DASH system is used to represent the video content data, and a media presentation description (MPD) of the DASH system carries the auxiliary data,
the obtaining the video content data and the auxiliary data comprises obtaining, by a client of the DASH system, the media representation and the MPD corresponding to the media representation that are sent by a server of the DASH system;
the determining the presentation manner of the video content data based on the auxiliary data comprises parsing, by the client, the MPD to obtain the quality information of the at least two picture regions; and
the presenting the video picture in the presentation manner of the video content data comprises processing and presenting, by the client based on the quality information, a corresponding video picture represented by the media representation.

12. The method according to claim 1, wherein
the method is applied to a video track transmission system, a raw stream of the video track transmission system carries the video content data, and the raw stream and the auxiliary data are encapsulated in a video track in the video track transmission system,
the obtaining the video content data and the auxiliary data comprises obtaining, by a receive end of the video track transmission system, the video track sent by a generator of the video track transmission system;
the determining the presentation manner of the video content data based on the auxiliary data comprises parsing, by the receive end, the auxiliary data to obtain the quality information of the at least two picture regions; and
the presenting the video picture in the presentation manner of the video content data comprises processing and presenting, by the receive end based on the quality information, the video picture obtained by decoding the raw stream in the video track.

13. A client for presenting video information, comprising:
a non-transitory memory having processor-executable instructions stored thereon; and
a processor, coupled to the memory, configured to execute the processor-executable instructions to cause the client to:
obtain video content data and auxiliary data, wherein the video content data is configured to reconstruct a video picture, the video picture comprises at least two picture regions, and the auxiliary data comprises quality information of the at least two picture regions;
determine a presentation manner of the video content data based on the auxiliary data; and
present the video picture in the presentation manner of the video content data.

14. The client according to claim 13, wherein the at least two picture regions comprise a first picture region and a second picture region, the first picture region does not overlap the second picture region, and the first picture region and the second picture region have different picture quality indicated by the quality information.

15. The client according to claim 14, wherein the auxiliary data further comprises location information and size information of the first picture region in the video picture; and
the processor is configured to execute the processor-executable instructions to cause the client to determine to present, at a quality rank of the first picture region, a picture that is in the first picture region and that is determined by using the location information and the size information.

16. The client according to claim 15, wherein the second picture region is a picture region other than the first picture region in the video picture, and the processor is configured to execute the processor-executable instructions to cause the client to determine to present the second picture region at a quality rank of the second picture region.

17. The client according to claim 14, wherein the auxiliary data further comprises a first identifier that indicates whether or not a region edge of the first picture region is in a smooth state; and
when the first identifier indicates that the region edge of the first picture region is not in a smooth state, the processor is configured to execute the processor-executable instructions to cause the client to determine to smooth the region edge of the first picture region.

18. The client according to claim 17, wherein the auxiliary data further comprises a second identifier of a smoothing method used for the smoothing; and
when the first identifier indicates that the region edge of the first picture region is to be smoothed, the processor is configured to execute the processor-executable instructions to cause the client to determine to smooth the region edge of the first picture region by using the smoothing method corresponding to the second identifier.

19. The client according to claim 18, wherein the smoothing method comprises grayscale transformation, histogram equalization, low-pass filtering, or high-pass filtering.

20. A non-transitory computer readable medium having processor-executable instructions stored thereon that when executed by a processor, cause a client to:
obtain video content data and auxiliary data, wherein the video content data is configured to reconstruct a video picture, the video picture comprises at least two picture regions, and the auxiliary data comprises quality information of the at least two picture regions;
determine a presentation manner of the video content data based on the auxiliary data; and
present the video picture in the presentation manner of the video content data.
